(19) United States
(12) Patent Application Publication
(10) Pub. No.: US 2018/0078926 A1
(43) Pub. Date: Mar. 22, 2018

(54) RUTHENIUM SUPPORTED ON SUPPORTS HAVING A RUTILE PHASE AS STABLE CATALYSTS FOR NH3-SLIP APPLICATIONS

(71) Applicant: Johnson Matthey Public Limited Company, London (GB)

(72) Inventors: Hai-Ying CHEN, Wayne, PA (US); Kevin DOURA, Audubon, PA (US); Joseph FEDEYTKO, Wayne, PA (US); Janet FISHER, Reading (GB); John KILMARTIN, Reading (GB)

(21) Appl. No.: 15/712,271

(22) Filed: Sep. 22, 2017

Related U.S. Application Data
(60) Provisional application No. 62/398,029, filed on Sep. 22, 2016.

(51) Int. Cl. B01J 23/89; B01J 23/46; B01J 21/06; B01J 21/12; B01J 23/42; B01D 53/94

(52) U.S. Cl. CPC B01J 23/8926; B01J 23/462; B01J 21/063; B01J 21/12; B01J 23/42; B01D 53/9418; F01N 3/2066; B01D 2255/1026; B01D 2255/1021; B01D 2255/20761; B01D 2255/9022; B01D 2255/9032; B01D 2255/904; B01D 53/944

(57) ABSTRACT

An ammonia slip catalyst (ASC) comprising a first SCR catalyst, an oxidation catalyst comprising ruthenium or a Ru mixture, such as a Pt and Ru mixture, on a support comprising a rutile phase and a substrate is described. In some configurations, the ASC comprises a second oxidation catalyst. In other configurations, the ASC comprises a second oxidation catalyst and a third oxidation catalyst. The ASC's are useful for selective catalytic reduction (SCR) of NOx in exhaust gases and in reducing the amount of ammonia slip. Methods for producing such articles are described. Methods of using the ammonia slip catalyst in an SCR process, where the amount of ammonia slip is reduced, are also described.

### CROSS REFERENCE TO RELATED APPLICATIONS

This application claims priority benefit to U.S. Provisional Patent Application No. 62/389,029 filed on Sep. 22, 2016, which is incorporated herein by reference.

### FIELD OF THE INVENTION

The invention relates to ammonia slip catalysts (ASC) comprising ruthenium on a support having a rutile phase, articles containing these ammonia slip catalysts and methods of manufacturing and using such articles to reduce ammonia slip.

### BACKGROUND OF THE INVENTION

Hydrocarbon combustion in diesel engines, stationary gas turbines, and other systems generates exhaust gas that must be treated to remove nitrogen oxides (NOx), which comprises NO (nitric oxide) and NO₂ (nitrogen dioxide), with NO being the majority of the NOx formed. NOx is known to cause a number of health issues in people as well as causing a number of detrimental environmental effects including the formation of smog and acid rain. To mitigate both the human and environmental impact from NOₓ in exhaust gas, it is desirable to eliminate these undesirable components, preferably by a process that does not generate other noxious or toxic substances.

Exhaust gas generated in lean-burn and diesel engines is generally oxidative. NOx needs to be reduced selectively with a catalyst and a reductant in a process known as selective catalytic reduction (SCR) that converts NOx into elemental nitrogen (N₂) and water. In an SCR process, a gaseous reductant, typically anhydrous ammonia, aqueous ammonia, or urea, is added to an exhaust gas stream prior to the exhaust gas contacting the catalyst. The reductant is absorbed onto the catalyst and the NOₓ is reduced as the gases pass through or over the catalyzed substrate. In order to maximize the conversion of NOx, it is often necessary to add more than a stoichiometric amount of ammonia to the gas stream. However, release of the excess ammonia into the atmosphere would be detrimental to the health of people and to the environment. In addition, ammonia is caustic, especially in its aqueous form. Condensation of ammonia and water in regions of the exhaust line downstream of the exhaust catalysts can result in a corrosive mixture that can damage the exhaust system. Therefore, the release of ammonia in exhaust gas should be eliminated. In many conventional exhaust systems, an ammonia oxidation catalyst (also known as an ammonia slip catalyst or “ASC”) is installed downstream of the SCR catalyst to remove ammonia from the exhaust gas by converting it to nitrogen. The use of ammonia slip catalysts can allow for NOₓ conversions of greater than 90% over a typical diesel driving cycle.

The use of Ru on rutile and other metal oxide supports for N₂O decomposition using 30% N₂O and 70% argon has been described by Qingquan Lin, et al. (J. Mater. Chem. A. 2014, 2, 5178) FIG. 1 (from Lin et. al.) shows N₂O conversion at temperatures between 160 and 300° C. using various RuO₂ catalysts with 30 vol % N₂O and 70% Ar. For all of the metal supports tested, there was less than about 10% N₂O conversion from 160 to 200° C. The amount of conversion then increased as the temperature increased to 300° C., with rutile being the only support that provided greater than 50% N₂O conversion. One skilled in the art would recognize that the conditions used in Lin et al. (30 vol % N₂O) do not represent conditions found in exhaust from engines, where the concentrations of N₂O is generally in the range of several hundred ppm along with the presence of H₂O and oxygen which would increase the N₂O decomposition temperature.

It would be desirable to have a catalyst that provides for both NOx removal by SCR and for selective ammonia conversion to nitrogen, where ammonia conversion occurs over a wide range of temperatures in a vehicle's driving cycle, and minimal nitrogen oxide and nitrous oxide byproducts are formed.

### SUMMARY OF THE INVENTION

In a first aspect, the invention relates to an ammonia slip catalyst (ASC) comprising: a first SCR catalyst and an oxidation catalyst comprising ruthenium or a ruthenium mixture on a support comprising a rutile phase, where the ASC is located on a substrate.

In a second aspect, the invention relates to a catalyst comprising an ammonia slip catalyst of the first aspect of the invention and a second SCR catalyst, where the ASC is located on the substrate and at least a portion of the second SCR covers at least a portion of the top of the ASC.

In a third aspect, the invention relates to a catalyst comprising an ammonia slip catalyst of the first aspect of the invention, a second SCR catalyst and a third SCR catalyst, where the third SCR catalyst is located on the substrate, the ASC catalyst is located over at least a portion of the third SCR catalyst, and the second SCR catalyst is located over at least a portion of the ASC.

In a fourth aspect, the invention relates to an an exhaust system comprising a catalyst of the first, second or third aspects of the invention and a means for forming NH₃ in the exhaust gas.

In a fifth aspect, the invention relates to a vehicle comprising an exhaust system comprising a catalyst of the first, second or third aspects of the invention and a means for forming NH₃ in the exhaust gas.

In a sixth aspect, the invention relates to methods of improving the N₂ yield from ammonia in an exhaust gas at a temperature from about 250° C. to about 350° C. by contacting an exhaust gas comprising ammonia with a catalyst article of the first, second or third aspects of the invention. In some embodiments, the invention relates to methods of improving the N₂ yield from ammonia in an exhaust gas at a temperature from about 300° C. to about 400° C. by contacting an exhaust gas comprising ammonia with a catalyst article of the first, second or third aspects of the invention.

In a seventh aspect, the invention relates to a method of reducing N₂O formation from NH₃ in an exhaust gas, the method comprising contacting an exhaust gas comprising ammonia with a catalyst article of the first, second or third aspects of the invention.

### BRIEF DESCRIPTION OF THE DRAWINGS

FIG. 1 is a graph showing N₂O conversion at temperatures between 160 and 300° C. using various RuO₂ catalysts with 30 vol % N₂O and 70% Ar.

FIG. 2 is a graph showing N₂O conversion at temperatures between 150 and 550° C. using Ru on rutile with 400 ppm N₂O and either 0% or 10% O₂ with the balance being N₂.

FIG. 3 is a graph showing the percent ammonia conversion and N₂O yield using fresh Pt on alumina and Ru on alumina.

FIG. 4 is a graph showing the percent ammonia conversion and N₂O yield using aged Pt on alumina and Ru on alumina.

FIG. 5 is an X-ray diffraction (XRD) pattern of anatase TiO₂.

FIG. 6 is an XRD pattern of rutile TiO₂.

FIG. 7 is a graph showing an overlay of the XRD patterns of anatase and rutile TiO₂.

FIG. 8 is a simulated XRD pattern of ruthenium oxide.

FIG. 9 is an XRD pattern of 3% Ru on anatase TiO₂.

FIG. 10 is a graph showing an overlay of the XRD patterns of anatase TiO₂, RuO₂, and RuO₂ on anatase TiO₂.

FIG. 11 is an XRD pattern of 3% Ru on rutile TiO₂.

FIG. 12 is an XRD pattern of 5% Ru on rutile TiO₂.

FIG. 13 is a graph of XRD patterns of rutile TiO₂ and 5% Ru on rutile.

FIG. 14 is an XRD pattern of 3% Ru on a mixture of anatase and rutile TiO₂.

FIG. 15 is a diagram of a configuration in which an ASC catalyst is a single layer catalyst comprising an SCR/ASC mixture of a first SCR catalyst and Ru or a Ru mixture, such as a Pt and Ru mixture, on a support having a rutile phase, where the SCR/ASC mixture is positioned on a substrate.

FIG. 16 is a diagram of a configuration in which an ASC catalyst is a bi-layer with a top layer comprising a first SCR catalyst and a bottom layer comprising Ru or a Ru mixture, such as a Pt and Ru mixture, on a support having a rutile phase. where the bottom layer is positioned on a substrate.

FIG. 17 is a diagram of a configuration in which an ASC catalyst is a single layer catalyst comprising a first zone and a second zone, where the first zone comprises a first SCR catalyst and the second zones comprises Ru or a Ru mixture, such as a Pt and Ru mixture, on a support having a rutile phase, where the first zone is located adjacent to, and upstream of, the second zone and the first zone and the second zone are positioned on a substrate.

FIG. 18 is a diagram of a configuration in which an ASC catalyst comprising a first zone and a second zone, where the first zone comprises a first SCR catalyst and the second zone comprises Ru or a Ru mixture, such as a Pt and Ru mixture, on a support having a rutile phase, where the first zone is located adjacent to, and upstream of, the second zone, the second zone comprises a portion having a stepped shape, and a portion of the first zone covers the portion of the second zone having the stepped shape.

FIG. 19 is a diagram of a configuration in which an ASC catalyst is a single layer catalyst comprising a first zone comprising a mixture of a first SCR catalyst and Ru or a Ru mixture, such as a Pt and Ru mixture, on a support having a rutile phase and a second zone, comprising a mixture of Pt and a first SCR, where the first zone is located adjacent to, and upstream of, the second zone and the first zone and the second zone are positioned on a substrate.

FIG. 20 is a diagram of a configuration in which a top layer comprising a second SCR catalyst is located over a bottom layer comprising an ASC, where the ASC is in one of the configurations shown in FIGS. 15-19, and the bottom layer is positioned on a substrate.

FIG. 21 is a diagram of a configuration in which a layer comprising a second SCR catalyst is located both adjacent to, and completely covers, an ASC layer, where the ASC is in one of the configurations shown in FIGS. 15-19, the portion of the second SCR catalyst adjacent to the bottom layer is located upstream of the bottom layer, and both the ASC layer and the portion of the second SCR layer adjacent to the ASC layer are positioned on a substrate.

FIG. 22 is a diagram of a configuration in which a layer comprising a second SCR catalyst is located both adjacent to, and partially covers, an ASC layer, where the ASC is in one of the configurations shown in FIGS. 15-19, the portion of the second SCR catalyst adjacent to the bottom layer is located upstream of the bottom layer, and both the ASC layer and the portion of the second SCR layer adjacent to the ASC layer are positioned on a substrate.

FIG. 23 is a diagram of a configuration in which a layer comprising a second SCR catalyst is located both adjacent to, and completely covers, an ASC layer, where the ASC is in one of the configurations shown in FIGS. 15-19, the portion of the second SCR catalyst adjacent to the bottom layer is located downstream of the bottom layer, and both the ASC layer and the portion of the second SCR layer adjacent to the ASC layer are positioned on a substrate.

FIG. 24 is a diagram of a configuration in which a layer comprising a second SCR catalyst is located both adjacent to, and partially covers, an ASC layer, where the ASC is in one of the configurations shown in FIGS. 15-19, the portion of the second SCR catalyst adjacent to the bottom layer is located upstream of the ASC layer, and both the ASC layer and the portion of the second SCR layer adjacent to the ASC layer are positioned on a substrate.

FIG. 25 is a diagram of a configuration in which three layers are located over a substrate, where the bottom layer, which is located on the substrate, comprises a third SCR catalyst, the bottom layer is partially covered by a middle layer comprising an ASC layer, where the ASC is in one of the configurations shown in FIGS. 15-19, and a top layer, comprising a second SCR catalyst, completely covers the middle layer, where the uncovered portion of the bottom layer in on the upstream portion of the bottom layer.

FIG. 26 is a diagram of a configuration in which three layers are located over a substrate, where the bottom layer, which is located on the substrate, comprises a third SCR catalyst, the bottom layer is partially covered by a middle layer comprising an ASC layer, where the ASC is in one of the configurations shown in FIGS. 15-19, and a top layer, comprising a second SCR catalyst, completely covers the middle layer, where the uncovered portions of the bottom layer and the middle layer are on the upstream portion of the bottom layer and the ASC layer, respectively.

FIG. 27 is a diagram of a configuration in which three layers are located over a substrate, where the bottom layer, which is located on the substrate, comprises a third SCR catalyst, the bottom layer is partially covered by a middle layer comprising an ASC layer, where the ASC is in one of the configurations shown in FIGS. 15-19, and a top layer, comprising a second SCR catalyst, partially covers the middle layer, where the bottom layer contains two portions that are not covered by the middle layer, where the two portions are from the inlet end and the outlet e, and a portion of the top layer is located downstream, adjacent to the ASC layer and is located over the bottom layer.

FIG. 28 is a diagram of a configuration in which a single layer blend of an ammonia slip catalyst comprising the 1st SCR catalyst and Ru or a Ru mixture, such as a Pt and Ru mixture, on a support having a rutile phase is located on each side of a substrate containing a third SCR catalyst.

FIG. 29 is a diagram of a configuration in which a bi-layer coating having a bottom layer comprising a mixture of Ru or a Ru mixture, such as a Pt and Ru mixture, on a support having a rutile phase and a first SCR catalyst with a top layer comprising a second SCR catalyst is located on each side of a substrate containing a third SCR catalyst.

FIG. 30 is a graph showing the percent ammonia conversion using fresh Ru on an approximately 3:1 mixture of anatase:rutile (P25 TiO₂), Ru on rutile TiO₂ and Pt on alumina.

FIG. 31 is a graph showing the percent ammonia conversion using aged Ru on an approximately 3:1 mixture of anatase:rutile (P25 TiO₂) and Ru on rutile TiO₂.

FIG. 32 is a graph showing N₂O formation using fresh Ru on an approximately 3:1 mixture of anatase:rutile (P25 TiO₂), Ru on rutile TiO₂ and Pt on alumina.

FIG. 33 is a graph showing N₂O formation using aged Ru on an approximately 3:1 mixture of anatase:rutile (P25 TiO₂) and Ru on rutile TiO₂.

FIG. 34 is a graph showing N₂O selectivity using fresh Ru on an approximately 3:1 mixture of anatase:rutile (P25 TiO₂), Ru on rutile TiO₂, and alumina and Pt on alumina.

FIG. 35 is a graph showing N₂O selectivity using aged Ru on rutile TiO₂ and alumina and Pt on alumina.

FIG. 36 is a graph showing NO₂ selectivity using fresh Ru on rutile TiO₂ and alumina and Pt on alumina.

FIG. 37 is a graph showing NO₂ selectivity using aged Ru on rutile TiO₂ and alumina and Pt on alumina.

### DETAILED DESCRIPTION OF THE INVENTION

As used in this specification and the appended claims, the singular forms “a”, “an” and “the” include plural referents unless the context clearly indicates otherwise. Thus, for example, reference to “a catalyst” includes a mixture of two or more catalysts, and the like.

The term “rutile” means a polymorph of titanium dioxide having a tetragonal ditetragonal dipyramidal crystal system and a body-centered tetragonal unit cell. The term “rutile group” refers to a group of metal oxides having the formula MO₂ and a tetragonal crystal system with a ditetragonal dipyramidal class. Members of the rutile group are rutile (TiO₂), stishovite (SiO₂), pyrolusite (MnO₂), cassiterite (SnO₂), plattnerite (PbO₂), argutite (GeO₂), paratellurite (TeO₂), tripuhyite (Fe³⁺Sb⁵⁺O₄) and IrO₂. The rutile group may also include doped rutile phase materials, i.e. rutile phase material that includes two or more dopants yet retains a rutile structure. Examples include Nb doped TiO₂ (Ti₁₋ₓNbₓO₂ where x=0 to 0.06) and In and Ta doped TiO₂ ((In_{0.5}Ta_{0.5})ₓTi₁₋ₓO₂ where x=0.05, 0.5, and 0.1). The dopant concentration may range from 0.05-0.5 weight percent relative to the metal oxide host.

The term “rutile phase” means a composition comprising one or more members of the rutile group.

The term a “Ru mixture” means a mixture comprising an oxide of ruthenium and an oxide of at least one metal. Preferably, the metal is a metal that converts CO. In some embodiments, the metal that converts CO is platinum. Other metals may be present in the mixture.

The term “Pt and Ru mixture” may include an alloy of platinum and ruthenium, a Pt and Ru mixed metal oxide, a mixture of discrete Pt and Ru oxide particles on a support, or combinations thereof, each where ruthenium is present at greater than 50 mole %.

The term “ammonia slip”, means the amount of unreacted ammonia that passes through the SCR catalyst.

The term “support” means the material to which a catalyst is fixed.

The term “a support with low ammonia storage” means a support that stores less than 0.001 mmol NH₃ per m³ of support. The support with low ammonia storage is preferably a molecular sieve or zeolite having a framework type selected from the group consisting of AEI, ANA, ATS, BEA, CDO, CFI, CHA, CON, DDR, EM, FAU, FER, GON, IFR, IFW, IFY, IHW, IMF IRN, IRY, ISV, ITE, ITG, ITN, ITR, ITW, IWR, IWS, IWV, IWW, JOZ, LTA, LTF, MEL, MEP, MFI, MRE, MSE, MTF, MTN, MTT, MTW, MVY, MWW, NON, NSI, RRO, RSN, RTE, RTH, RUT, RWR, SEW, SFE, SFF, SFG, SFH, SFN, SFS, SFV, SGT, SOD, SSF, SSO, SSY, STF, STO, STT, SVR, SVV, TON, TUN, UOS, UOV, UTL, UWY, VET, VNI. More preferably, the molecular sieve or zeolite has a framework type selected from the group consisting of BEA, CDO, CON, FAU, MEL, MFI and MWW, even more preferably the framework type is selected from the group consisting of BEA and MFI.

The term “calcine”, or “calcination”, means heating the material under an oxidizing atmosphere, such as air or oxygen, a neutral atmosphere, such as nitrogen or other inert gas, or a reducing atmosphere, such as hydrogen. The atmosphere can be dry or can include water. Calcination can be performed to remove organic structure directing agents (templates), to decompose a metal salt and promote the exchange of metal ions within the catalyst. Calcination also helps to adhere the catalyst to a support. The temperatures used in calcination depend upon the components in the material to be calcined and generally are between about 400° C. to about 900° C. for approximately 1 to 8 hours. In some cases, calcination can be performed up to a temperature of about 1200° C. In applications involving the processes described herein, calcinations are generally performed at temperatures from about 400° C. to about 700° C. for approximately 1 to 8 hours, preferably at temperatures from about 400° C. to about 650° C. for approximately 1 to 4 hours.

The term “durability” means that the material with Ru on a rutile phase has better activity after hydrothermal aging at either 550 or 650° C. for 100 hours than a similar material where Ru is on a support that does not comprise a rutile phase.

When a range, or ranges, for various numerical elements are provided, the range, or ranges, can include the values, unless otherwise specified.

The term “N₂ selectivity” means the percent conversion of ammonia into nitrogen.

The term “upstream” means a configuration in which an exhaust gas flow from a first element to a second element. The first element is upstream of the second element relative to the flow of the exhaust gas. The second element is “downstream” of the first element relative to the flow of the exhaust gas.

The term “similar”, when referring to a composition, means that the components are the same except that a support having a rutile phase is not present. A different support may be present in place of the support comprising a rutile phase. The composition of the components by weight is approximately the same, taking into consideration variations due to the absence of the support having a rutile phase, when a different support is used in place of a support having a rutile phase for comparison.

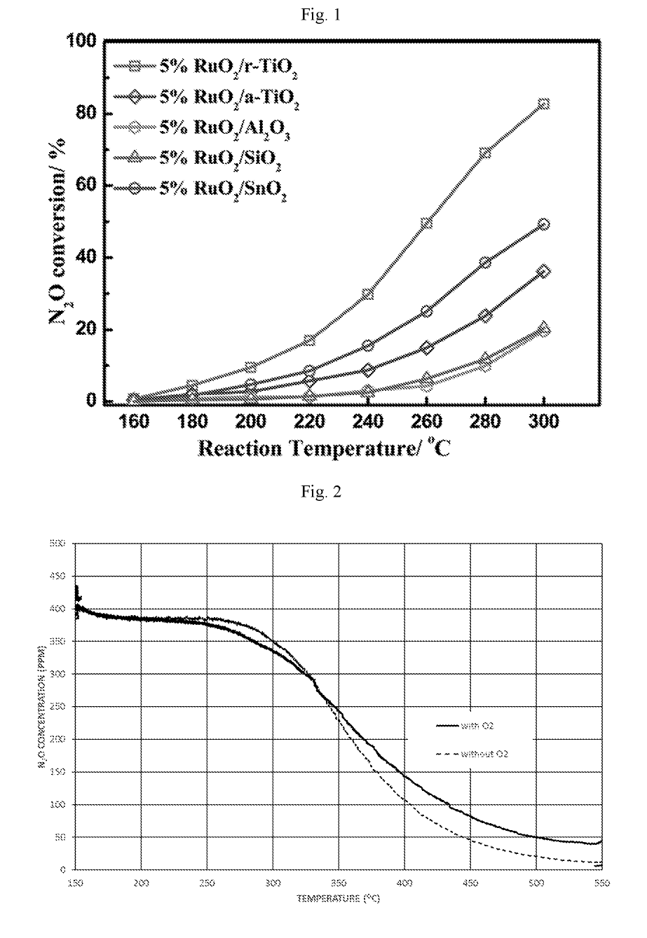

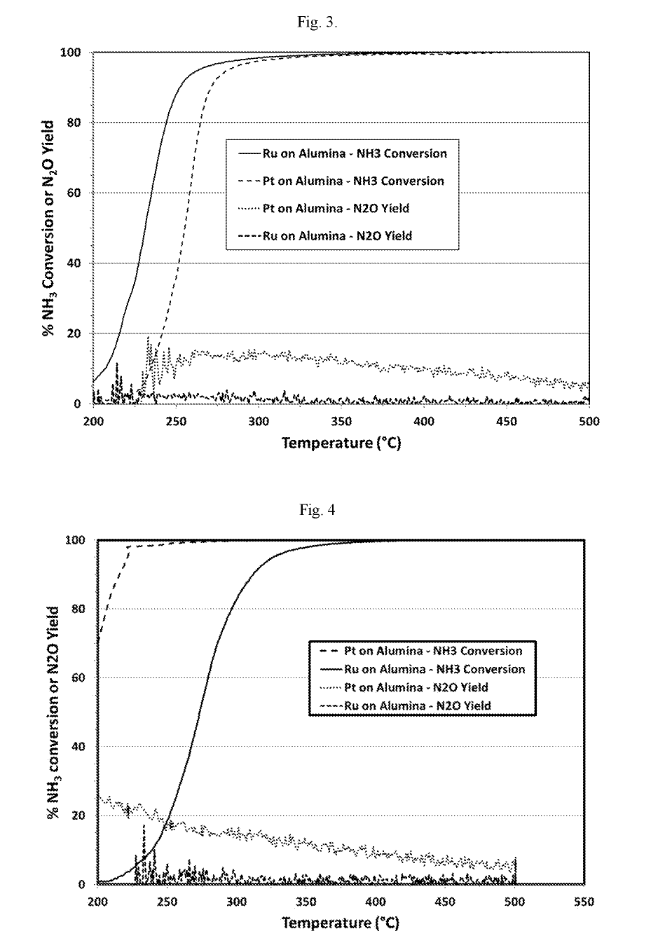

Platinum has widely been used as a catalyst for the oxidation of hydrocarbons (HC) and carbon monoxide (CO) and for the promotion of the reaction of CO with nitrogen oxides (NOx) to form nitrogen gas. Platinum is often used on an alumina support. One of the problems associated with the use of platinum is the formation of nitrous oxide (N₂O), a regulated exhaust gas. N₂O is a major greenhouse gas as is considered to have between about 250 to 300 times more impact per unit mass on global warming than carbon dioxide. The use of ruthenium on an alumina support results in a significant reduction in the amount of N₂O formed compared to platinum. This reduction in N₂O formation is found on both fresh and aged catalyst. (See FIGS. 1 and 2) However, one of the potential problems associated with the use of ruthenium as a catalyst is its known volatility at temperatures that exhaust gas catalysts are exposed.

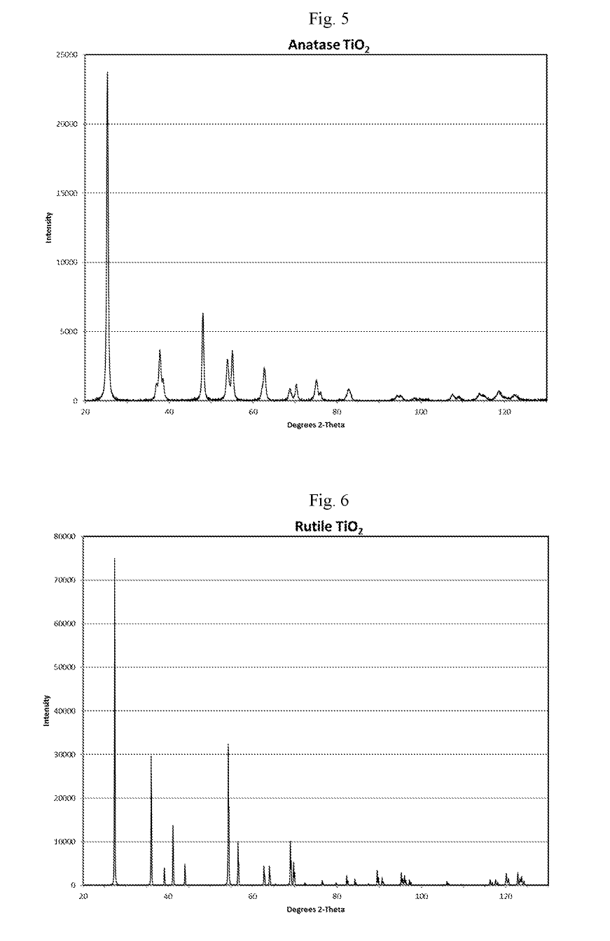

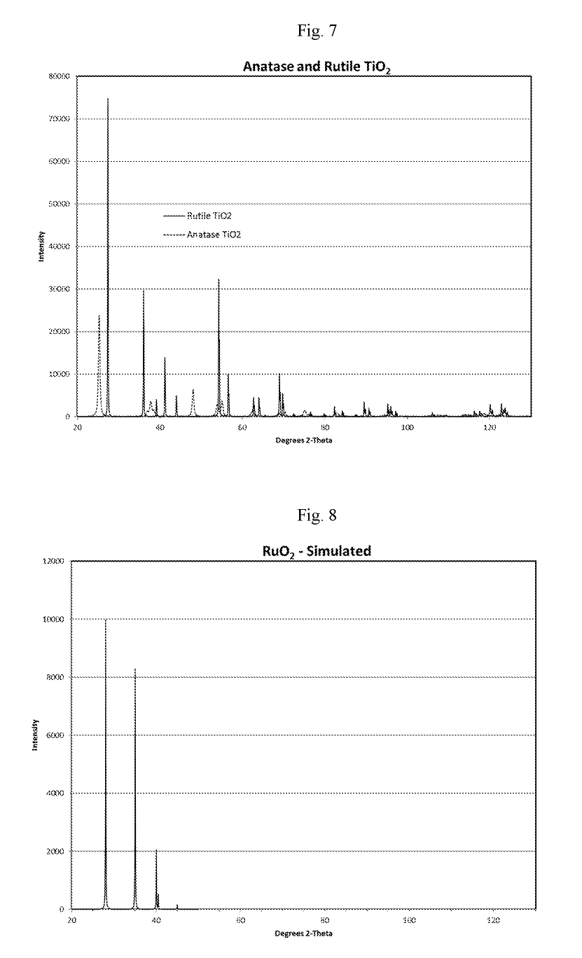

Ruthenium is generally present as ruthenium oxide (RuO₂) in catalysts used for treating exhaust gases from engines. Ruthenium oxide has a rutile structure. Rutile, one of three mineral forms of titanium dioxide, has a body-centred tetragonal unit cell. Diebold, Ulrike (2003). “The surface science of titanium dioxide”. Surface Science Reports 48 (5-8): 53-229. Anatase, another mineral form of titanium dioxide, can be present in two type of crystals: pyramidal and tabular. X-ray diffraction (XRD) patterns of anatase titanium dioxide and rutile titanium dioxide are shown in FIGS. 5 and 6. FIG. 7 shows an overlay of the XRD patterns of anatase and rutile TiO₂. The major peaks of anatase TiO₂ at 25.3, 37.7 and 48.0 2θ° are not present in the XRD pattern of rutile TiO₂. Similarly, the major XRD peaks of rutile TiO₂ at 27.4, 36.0, 41.2 and 56.6 2θ° are not present in the XRD pattern of anatase TiO₂. The major peak of rutile TiO₂ at 54.2 2θ° is between two peaks of anatase 2θ°.

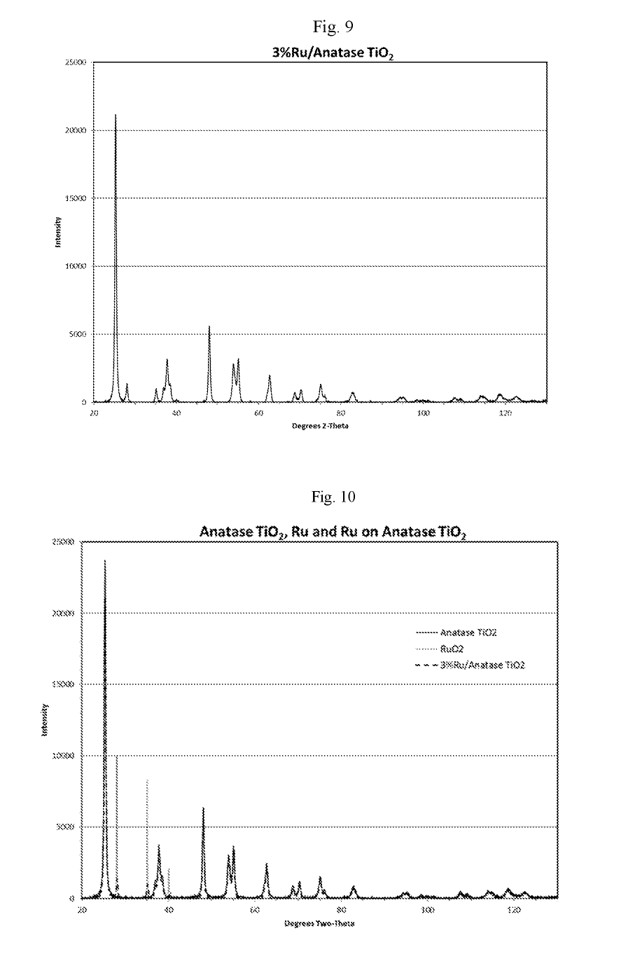

A simulated XRD pattern of ruthenium oxide (FIG. 8) shows that RuO₂ has three major peaks at about 28.0, 35.0 and 40.0 2θ° and minor peaks at about 40.5 and 45.0 2θ°. An XRD pattern of RuO₂ on anatase TiO₂ at a loading of 3% Ru by weight (FIG. 9) shows that RuO₂ is present in its native form as indicated by the peaks at 28.2 and 35.5 2θ°. An overlay of XRD patterns from anatasae TiO₂, RuO₂, and 3% Ru on anatase TiO₂ is shown in FIG. 10. The peaks at 28.0 and 35.1 2θ° indicate that the RuO₂ is present in a different structure than anatase.

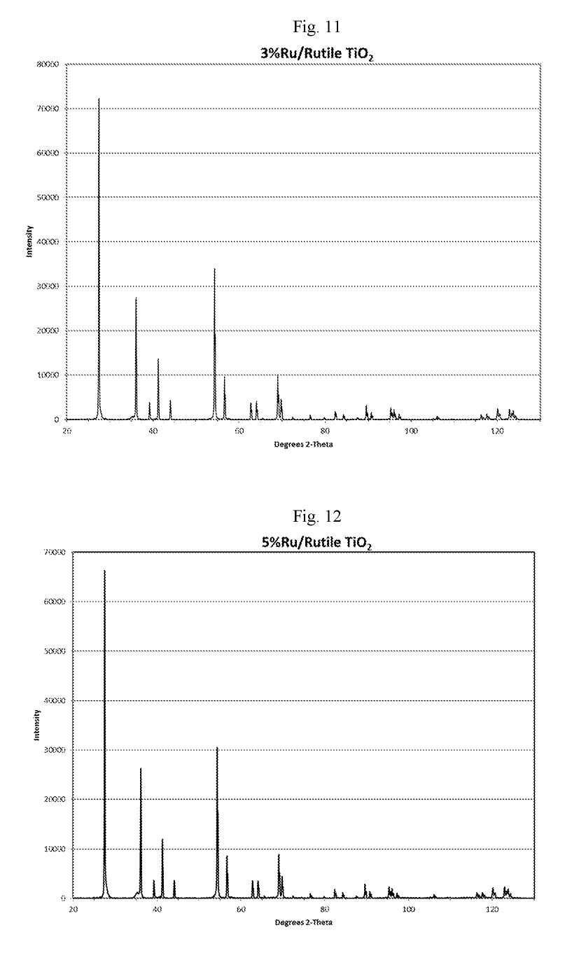

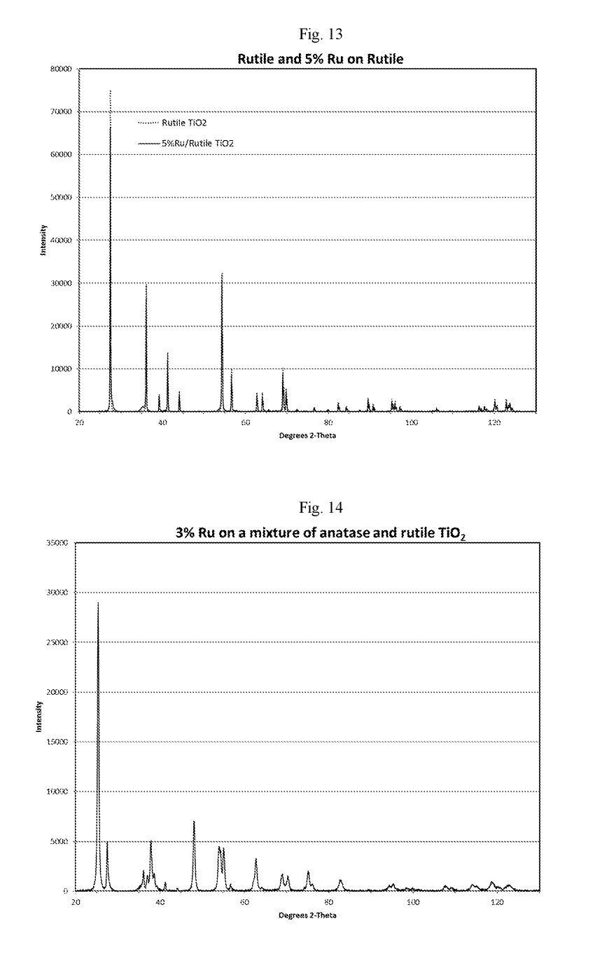

The XRD patterns of RuO₂ on rutile TiO₂ at loadings of 3% and 5% Ru by weight (FIGS. 11 and 12) shows RuO₂ is not present in its native form but rather has taken the form of rutile because the peaks of RuO₂ in native form are absent in the XRD patterns of RuO₂ on rutile TiO₂. An overlay of the XRD patterns of rutile and 5% Ru on rutile is shown in FIG. 13. The absence of peaks at 28.0, 35.0 and 40.1 2θ° indicate that the RuO₂ is highly dispersed on a rutile phase support not giving strong reflections in the XRD pattern.

A commercially available powder form of titanium dioxide, P25, is manufactured by Evonik. P25 is a mixture of anatase to rutile at a ratio of about 3:1. An XRD pattern of 3% RuO₂ on P25 is shown in FIG. 14. The XRD pattern is similar to the XRD pattern in FIG. 7, which is a combination of anatase and rutile TiO₂. Even though anatase makes up about 75% of the P25 support, XRD peaks associated with Ru on anatase are not observed due to the presence of discreet RuO₂ peaks at 28 and 35 2θ°.

The volatility of ruthenium when placed on rutile TiO₂ may decrease due to the similarity in structures between these two materials allowing the Ru to strongly interact with the support.

In a first aspect of the invention, the invention relates to an ammonia slip catalyst (ASC) comprising: a first SCR catalyst, an oxidation catalyst comprising ruthenium or a Ru mixture on a support comprising a rutile phase, such as rutile, and a substrate having an inlet end and an outlet end and a length defined by the distance between the inlet end and the outlet end. In some embodiments, the Ru mixture is a Pt and Ru mixture. The ammonia slip catalyst can have reduced volatility of ruthenium compared to ruthenium on a non-rutile phase support under high temperature oxidizing conditions, such as above 300° C.

The rutile phase preferably is in the form nano-sized particles having a particle size between 1 and 100 nanometers, inclusive.

The rutile phase can further comprise one or more stabilizing agents. The stabilizing agent can comprise a metal oxide, such as alumina or silica. The stabilizing agent can increase the durability of the Ru containing catalyst. The stabilizing agent can be added to the rutile phase before Ru is added to the rutile phase, during the addition of Ru to the rutile phase or after addition of Ru to the rutile phase, preferably before the addition of Ru to the rutile phase.

The ammonia slip catalyst can further comprise one or more promoters combined with Ru and the rutile phase. The one or promoters can be selected from the group consisting of copper, nickel, zinc, iron, tungsten, molybdenum, cobalt, titanium, zirconium, manganese, chromium, vanadium, niobium, tin, bismuth, antimony, ruthenium, rhodium, palladium, indium, iridium, platinum, gold, silver, or combinations of two or more of these. In some embodiments, the one or more promoters is selected from the group consisting of copper, iron or manganese, more preferably, copper in the form of CuO, iron oxides or manganese oxides.

The promoter can be present in an amount from about 0.1 to about 10% relative to the weight of the ASC catalyst. The performance of the ASC catalyst for removal of ammonia can be increased by 1 to 20% relative to a comparable catalyst without the promoter.

The ammonia slip catalyst can be a bi-layer having a top layer comprising the first SCR catalyst and a bottom layer comprising the oxidation catalyst comprising ruthenium or a Ru mixture, such as a Pt and Ru mixture, on a support comprising a rutile phase.

The ammonia slip catalyst can comprise a single layer comprising a mixture of the first SCR catalyst and the oxidation catalyst comprising ruthenium or a Ru mixture, such as a Pt and Ru mixture, on a support comprising a rutile phase.

The oxidation catalyst can further comprise Pt in either a single layer or bi-layer configuration.

The ammonia slip catalyst can be a single layer comprising a first zone comprising a first SCR catalyst and ruthenium and a second zone comprising Pt, where the first zone is positioned on the inlet side of the second zone.

The first zone can extend over a length of the substrate that is at least equal to the length of the substrate covered by the second zone and is less than or equal to four times the length of the substrate covered by the second zone.

The first zone can extend over a length of the substrate that is at least equal to twice the length of the substrate covered by the second zone and is less than or equal to four times the length of the substrate covered by the second zone.

The first zone can extend over a length of the substrate that is at least equal to three times the length of the substrate covered by the second zone and is less than or equal to four times the length of the substrate covered by the second zone.

The ammonia slip catalyst having a single layer comprising a first zone comprising ruthenium and a second zone comprising Pt can have either or both of the zones comprise a mixture of the oxidation catalyst in the zone and the first SCR catalyst.

The ammonia slip catalyst can be a single layer with the first SCR catalyst located upstream of the oxidation catalyst. In this configuration, the first SCR catalyst and the oxidation catalyst are each in different, discrete zones.

The first SCR catalyst can be on the same substrate as ruthenium.

The first SCR catalyst can be on a different substrate than ruthenium.

The ammonia slip catalyst can comprise Ru and Pt, where Ru and Pt are on different supports.

The ammonia slip catalyst can comprise Ru and Pt, where Ru and Pt are on different supports and Pt is on a support with low ammonia storage.

The ammonia slip catalyst can be a single layer comprising Ru, Ru/rutile or a mixture of Ru/rutile and Pt/high silica.

The ammonia slip catalyst can be a single layer comprising a blend of the oxidation catalyst and the first SCR catalyst.

Ruthenium can be present at from 0.1 wt % to 10 wt %, inclusive, from 1 to 10 wt %, inclusive, from 2 wt % to 5 wt %, inclusive, relative to the weight of the ammonia slip catalyst.

The ammonia slip catalyst can have the first SCR catalyst and ruthenium on a support comprising a rutile phase on the same substrate, where 25 to 75%, or 40 to 65%, of the length of the substrate is covered by the first SCR catalyst and the remainder of the substrate is cover by ruthenium on a support comprising a rutile phase.

The ammonia slip catalysts described here can provide reduced ruthenium volatility compared to a similar ammonia slip catalyst not comprising a support comprising a rutile phase.

The ammonia slip catalyst can provide an improvement in N₂ yield from ammonia at a temperature from about 150° C. to about 350° C. compared to a similar ammonia slip catalyst comprising a comparable formulation in which ruthenium is on a support that does not comprise rutile.

The ammonia slip catalyst can provide reduced N₂O formation from NH₃ compared to an ammonia slip catalyst comprising a comparable formulation in which ruthenium is present on a support that is not rutile.

The catalyst can provide reduced N₂O formation compared to a comparable catalyst without Ru or a Ru mixture, such as a Pt and Ru mixture, on a support comprising a rutile support providing reduced ruthenium volatility.

An ASC catalyst can comprise: (a) an extruded substrate having an inlet, an outlet and a plurality of channels through which exhaust gas flows during operation of an engine, and (b) a single layer coating or a bi-layer coating on the substrate, where the extruded substrate comprises Ru supported on a rutile phase, the single layer coating comprises a blend of platinum on a support with low ammonia storage with a first SCR catalyst, and the bi-layer coating comprises a bottom layer and a top layer, where the bottom layer is located between the top layer and the extruded substrate, the bottom layer comprises a blend of platinum on a support with low ammonia storage with a first SCR catalyst, and the top layer comprises a second SCR catalyst. The support with low ammonia storage can be a siliceous support, where the siliceous support can comprise a silica or a zeolite with silica-to-alumina ratio of ≧100, preferably ≧200, more preferably ≧250, even more preferably ≧300, especially ≧400, more especially ≧500, even more especially ≧750, and most preferably ≧1000. The siliceous support preferably comprises BEA, CDO, CON, FAU, MEL, MFI or MWW. The extruded catalyst article can provide an improvement in N₂ yield from ammonia at a temperature from about 250° C. to about 300° C. compared to a catalyst comprising a comparable formulation in which the first SCR catalyst is present as a first layer and the platinum on a siliceous support is present in a second layer and gas comprising NH₃ passes through the first layer before passing through the second layer. The catalyst article can protect the platinum from one or more substances present in the catalyst that can poison the platinum, such as vanadium. The catalytic article may protect platinum from other poisons such as potassium, sodium, iron and tungsten. When the first SCR catalyst comprises vanadium, the catalyst article can provide reduced deactivation compared to a catalyst comprising a comparable formulation in which the first SCR catalyst is present as a first layer and the platinum on a siliceous support is present in a second layer and gas comprising NH₃ passes through the first layer before passing through the second layer.

The rutile phase in the ammonia slip catalysts described herein can further comprise one or more stabilizing agents. The stabilizing agent can comprise a metal oxide such as alumina or silica. The stabilizing agent can increase the durability of the Ru in the catalyst. The silica can be added to the rutile phase before Ru is added to the rutile phase, during the addition of Ru to the rutile phase or after addition of Ru to the rutile phase, preferably before the addition of Ru to the rutile phase.

The term “active component loading” refers to the weight of the support of platinum+the weight of platinum+the weight of the first SCR catalyst in the blend. Platinum can be present in the catalyst in an active component loading from about 0.01 to about 0.3 wt. %, inclusive, from about 0.03-0.2 wt. %, inclusive, from about 0.05-0.17 wt. %, inclusive, or from about 0.07-0.15 wt. %, inclusive.

SCR Catalysts In various configurations, the compositions can comprise one, two or three SCR catalysts.

The first SCR catalyst, which is always present in the compositions, is present in the top layer when the catalysts are present in a bilayer and Ru or a Ru mixture, such as a Ru and Pt mixture on rutile is present in a bottom layer. The first SCR catalyst is a base metal, an oxide of a base metal, a molecular sieve, a metal exchanged molecular sieve, a mixed oxide, or a mixture thereof. The molecular sieve is an aluminosilicate, an aluminophosphate (AlPO), a silico-aluminophosphate (SAPO), or mixtures thereof. The molecular sieve can have a Framework Type selected from the group consisting of ACO, AEI, AEN, AFN, AFT, AFX, ANA, APC, APD, ATT, BEA, CDO, CHA, DDR, DFT, EAB, EDI, EPI, EM, FER, GIS, GOO, IHW, ITE, ITW, KFI, LEV, LTA, MER, MFI, MON, NSI, OWE, PAU, PHI, RHO, RTH, SAT, SAV, SFW, SIV, THO, TSC, UEI, UFI, VNI, YUG and ZON and mixtures and/or intergrowths thereof. Preferably, the molecular sieve can have a Framework Type selected from the group consisting of AEI, AFX, BEA, CHA, DDR, EM, FER, ITE, KFI, LEV, LTA, MFI and SFW. In some embodiments, the first SCR is a Cu-SCR catalyst comprising copper and a molecular sieve, an Fe-SCR catalyst comprising iron and a molecular sieve, or a mixed oxide.

The SCR can be in a single layer blend with Ru or a Ru mixture, such as a Ru and Pt mixture on rutile. The first SCR catalyst may be a Cu-SCR catalyst, an Fe-SCR catalyst or a mixed oxide; a Cu-SCR catalyst or a mixed oxide; or a Cu-SCR catalyst. The Cu-SCR catalyst comprises copper and a molecular sieve. The Fe-SCR catalyst comprises iron and a molecular sieve. Molecular sieves are further described below. The molecular sieve can be an aluminosilicate, an aluminophosphate (AlPO), a silico-aluminophosphate (SAPO), or mixtures thereof. The copper or iron can be located within the framework of the molecular sieve and/or in extra-framework (exchangeable) sites within the molecular sieve.

In a second aspect, the invention relates to a catalyst comprising an ammonia slip catalyst (ASC) of the first aspect of the invention and a second SCR catalyst, where the ASC is located on the substrate and at least a portion of the second SCR covers at least a portion of the top of the ASC. In this aspect of the invention, the second SCR catalyst is in a layer that extends over at least a portion of the bi-layer ammonia slip catalyst.

In a third aspect, the invention relates to a catalyst comprising an ammonia slip catalyst (ASC) of the first aspect of the invention, a second SCR catalyst and a third SCR catalyst, where the third SCR catalyst is located on the substrate, the ASC catalyst is located over at least a portion of the third SCR catalyst, and the second SCR catalyst is located over at least a portion of the ASC. The third SCR catalyst is an underlayer located under the bottom layer of the bi-layer catalyst and is between the bottom layer of the ASC and the substrate.

The second and third SCR catalysts can be the same or different. The second and third SCR catalyst comprise a base metal, an oxide of a base metal, a noble metal, a molecular sieve, a metal exchanged molecular sieve or a mixture thereof. The base metal can be selected from the group consisting of cerium (Ce), chromium (Cr), cobalt (Co), copper (Cu), iron (Fe), manganese (Mn), molybdenum (Mo), nickel (Ni), tungsten (W) and vanadium (V), and mixtures thereof.

SCR compositions consisting of vanadium supported on a refractory metal oxide such as alumina, silica, zirconia, titania, ceria and combinations thereof are well known and widely used commercially in mobile applications. Typical compositions are described in U.S. Pat. Nos. 4,010,238 and 4,085,193, the entire contents of which are incorporated herein by reference. Compositions used commercially, especially in mobile applications, comprise TiO₂ on to which WO₃ and V₂O₅ have been dispersed at concentrations ranging from 5 to 20 wt. % and 0.5 to 6 wt. %, respectively. One or both of the second and third SCR catalysts can comprise a promoted Ce—Zr or a promoted MnO₂. Preferably, the promoter comprises Nb. The noble metal can be platinum (Pt), palladium (Pd), gold (Au) silver (Ag), ruthenium (Ru) or rhodium (Rh), or a mixture thereof. These catalysts may contain other inorganic materials such as SiO₂ and ZrO₂ acting as binders and promoters.

When the SCR catalyst is a base metal, the catalyst article can further comprise at least one base metal promoter. As used herein, a “promoter” is understood to mean a substance that when added into a catalyst, increases the activity of the catalyst. The base metal promoter can be in the form of a metal, an oxide of the metal, or a mixture thereof. The at least one base metal catalyst promoter may be selected from barium (Ba), calcium (Ca), cerium (Ce), iridum (Ir) lanthanum (La), magnesium (Mg), manganese (Mn), molybdenum (Mo), neodymium (Nd), niobium (Nb), praseodymium (Pr), strontium (Sr), tantalum (Ta), tin (Sn), zinc (Zn), zirconium (Zr) and oxides thereof. The at least one base metal catalyst promoter can preferably be IrO₂, MnO₂, Mn₂O₃, Fe₂O₃, SnO₂, CuO, CoO, CeO₂ and mixtures thereof. The at least one base metal catalyst promoter may be added to the catalyst in the form of a salt in an aqueous solution, such as a nitrate or an acetate. The at least one base metal catalyst promoter and at least one base metal catalyst, e.g., copper, may be impregnated from an aqueous solution onto the oxide support material(s), may be added into a washcoat comprising the oxide support material(s), or may be impregnated into a support previously coated with the washcoat.

The SCR catalyst can comprise a molecular sieve or a metal exchanged molecular sieve.

As is used herein “molecular sieve” is understood to mean a metastable material containing tiny pores of a precise and uniform size that may be used as an adsorbent for gases or liquids. The molecules which are small enough to pass through the pores are adsorbed while the larger molecules are not. The molecular sieve can be a zeolitic molecular sieve, a non-zeolitic molecular sieve, or a mixture thereof.

A zeolitic molecular sieve is a microporous aluminosilicate having any one of the framework structures listed in the Database of Zeolite Structures published by the International Zeolite Association (IZA). The framework structures include, but are not limited to those of the AEI, AFX, BEA, CHA, FAU, LTA, MFI and MOR types. Non-limiting examples of zeolites having these structures include beta zeolite, chabazite, faujasite, mordenite, silicalite, zeolite Y, ultrastable zeolite Y, zeolite X, and ZSM-5. Aluminosilicate zeolites can have a silica/alumina molar ratio (SAR) defined as SiO₂/Al₂O₃) from at least about 5, preferably at least about 20, with useful ranges of from about 10 to 200.

Any of the SCR catalysts can comprise a small pore, a medium pore or a large pore molecular sieve, or a mixture thereof. A “small pore molecular sieve” is a molecular sieve containing a maximum ring size of 8 tetrahedral atoms. A “medium pore molecular sieve” is a molecular sieve containing a maximum ring size of 10 tetrahedral atoms. A “large pore molecular sieve” is a molecular sieve having a maximum ring size of 12 tetrahedral atoms. The second and/or third SCR catalysts can comprise a small pore molecular sieve selected from the group consisting of aluminosilicate molecular sieves, metal-substituted aluminosilicate molecular sieves, aluminophosphate (AlPO) molecular sieves, metal-substituted aluminophosphate (MeAlPO) molecular sieves, silico-aluminophosphate (SAPO) molecular sieves, and metal substituted silico-aluminophosphate (MeAPSO) molecular sieves, and mixtures thereof.

Any of the SCR catalysts can comprise a small pore molecular sieve selected from the group of Framework Types consisting of ACO, AEI, AEN, AFN, AFT, AFX, ANA, APC, APD, ATT, CDO, CHA, DDR, DFT, EAB, EDI, EPI, EM, GIS, GOO, IHW, ITE, ITW, LEV, KFI, LTA, MER, MON, NSI, OWE, PAU, PHI, RHO, RTH, SAT, SAV, SIV, THO, TSC, UEI, UFI, VNI, YUG, and ZON, and mixtures and/or intergrowths thereof. Preferably the small pore molecular sieve is selected from the group of Framework Types consisting of AEI, AFX, CHA, DDR, EM, ITE, KFI, LEV, LTA and SFW.

Any of the SCR catalysts can comprise a medium pore molecular sieve selected from the group of Framework Types consisting of AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, -SVR, SZR, TER, TON, TUN, UOS, VSV, WEI, and WEN, and mixtures and/or intergrowths thereof. Preferably, the medium pore molecular sieve selected from the group of Framework Types consisting of FER, MFI and STT.

Any of the SCR catalysts can comprise a large pore molecular sieve selected from the group of Framework Types consisting of AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, and VET, and mixtures and/or intergrowths thereof. Preferably, the large pore molecular sieve is selected from the group of Framework Types consisting of BEA, MOR and OFF.

The molecular sieves in the Cu-SCR and Fe-SCR catalysts are preferably selected from the group consisting of ACO, AEI, AEN, AFN, AFT, AFX, ANA, APC, APD, ATT, BEA, CDO, CHA, DDR, DFT, EAB, EDI, EPI, EM, FER, GIS, GOO, IHW, ITE, ITW, KFI, LEV, LTA, MER, MFI, MON, NSI, OWE, PAU, PHI, RHO, RTH, SAT, SAV, SIV, THO, TSC, UEI, UFI, VNI, YUG and ZON and mixtures and/or intergrowths thereof. More preferably, the molecular sieves in the Cu-SCR and Fe-SCR are selected from the group consisting of AEI, AFX, BEA, CHA, DDR, EM, FER, ITE, KFI, LEV, LTA, MFI and SFW, and mixtures and/or intergrowths thereof.

A metal exchanged molecular sieve can have at least one metal from one of the groups VB, VIB, VIIB, VIIIB, IB, or IIB of the periodic table deposited onto extra-framework sites on the external surface or within the channels, cavities, or cages of the molecular sieves. Metals may be in one of several forms, including, but not limited to, zero valent metal atoms or clusters, isolated cations, mononuclear or polynuclear oxycations, or as extended metal oxides. Preferably, the metals can be iron, copper, and mixtures or combinations thereof.

The metal can be combined with the zeolite using a mixture or a solution of the metal precursor in a suitable solvent. The term “metal precursor” means any compound or complex that can be dispersed on the zeolite to give a catalytically-active metal component. Preferably the solvent is water due to both economics and environmental aspects of using other solvents. When copper, a preferred metal is used, suitable complexes or compounds include, but are not limited to, anhydrous and hydrated copper sulfate, copper nitrate, copper acetate, copper acetylacetonate, copper oxide, copper hydroxide, and salts of copper amines (e.g. [Cu(NH₃)₄]²⁺). This invention is not restricted to metal precursors of a particular type, composition, or purity. The molecular sieve can be added to the solution of the metal component to form a suspension, which is then allowed to react so that the metal component is distributed on the zeolite. The metal can be distributed in the pore channels as well as on the outer surface of the molecular sieve. The metal can be distributed in ionic form or as a metal oxide. For example, copper may be distributed as copper (II) ions, copper (I) ions, or as copper oxide. The molecular sieve containing the metal can be separated from the liquid phase of the suspension, washed, and dried. The resulting metal-containing molecular sieve can then be calcined to fix the metal in the molecular sieve. Preferably, the second and third catalysts comprise a Cu-SCR catalyst comprising copper and a molecular sieve, an Fe-SCR catalyst comprising iron and a molecular sieve, a vanadium based catalyst, a promoted Ce—Zr or a promoted MnO₂.

A metal exchanged molecular sieve can contain in the range of about 0.10% and about 10% by weight of a group VB, VIB, VIIB, VIIIB, IB, or IIB metal located on extra framework sites on the external surface or within the channels, cavities, or cages of the molecular sieve. Preferably, the extra framework metal can be present in an amount of in the range of about 0.2% and about 5% by weight.

The metal exchanged molecular sieve can be a copper (Cu) or iron (Fe) supported small pore molecular sieve having from about 0.1 to about 20.0 wt. % copper or iron of the total weight of the catalyst. More preferably copper or iron is present from about 0.5 wt. % to about 15 wt. % of the total weight of the catalyst. Most preferably copper or iron is present from about 1 wt. % to about 9 wt. % of the total weight of the catalyst.

The ratio of the amount of the first SCR catalyst to the amount of platinum on the support with low ammonia storage can be in the range of at least one of: (a) 0:1 to 300:1, (b) 3:1 to 300:1, (c) 7:1 to 100:1; and (d) 10:1 to 50:1, inclusive, based on the weight of these components. Platinum can be present from at least one of: (a) 0.01-0.3 wt. %, (b) 0.03-0.2 wt. %, (c) 0.05-0.17 wt. %, and (d) 0.07-0.15 wt. %, inclusive, relative to the weight of the support of platinum+the weight of platinum+the weight of the first SCR catalyst in the blend.

The ammonia slip control catalysts described herein can be used in the SCR treatment of exhaust gases from various engines. The engines can be on a vehicle, a stationary engine, an engine in a power plant, or a gas turbine.

One of the properties of a catalyst comprising a blend of platinum on a siliceous support with a first SCR catalyst, where the first SCR catalyst is a Cu-SCR or Fe-SCR catalyst, is that it can provide an improvement in N₂ yield from ammonia at a temperature from about 250° C. to about 350° C. compared to a catalyst comprising a comparable formulation in which the first SCR catalyst is present as a first layer and platinum is supported on a layer that stores ammonia is present in a second layer and gas comprising NH₃ passes through the first layer before passing through the second layer. Another property of a catalyst comprising a blend of platinum on a support with low ammonia storage with a first SCR catalyst, where the first SCR catalyst is a Cu-SCR catalyst or an Fe-SCR catalyst, is that it can provide reduced N₂O formation from NH₃ compared to a catalyst comprising a comparable formulation in which the first SCR catalyst is present as a first layer and platinum supported on a support that stores ammonia is present in a second layer and gas comprising NH₃ passes through the first layer before passing through the second layer.

The substrate for the catalyst may be any material typically used for preparing automotive catalysts that comprises a flow-through or filter structure, such as a honeycomb structure, an extruded support, a metallic substrate, or a SCRF. Preferably the substrate has a plurality of fine, parallel gas flow passages extending from an inlet to an outlet face of the substrate, such that passages are open to fluid flow. Such monolithic carriers may contain up to about 700 or more flow passages (or “cells”) per square inch of cross section, although far fewer may be used. For example, the carrier may have from about 7 to 600, more usually from about 100 to 400, cells per square inch (“cpsi”). The passages, which are essentially straight paths from their fluid inlet to their fluid outlet, are defined by walls onto which the SCR catalyst is coated as a “washcoat” so that the gases flowing through the passages contact the catalytic material. The flow passages of the monolithic substrate are thin-walled channels which can be of any suitable cross-sectional shape such as trapezoidal, rectangular, square, triangular, sinusoidal, hexagonal, oval, circular, etc. The invention is not limited to a particular substrate type, material, or geometry.

Ceramic substrates may be made of any suitable refractory material, such as cordierite, cordierite-α alumina, α-alumina, silicon carbide, silicon nitride, zirconia, mullite, spodumene, alumina-silica magnesia, zirconium silicate, sillimanite, magnesium silicates, zircon, petalite, aluminosilicates and mixtures thereof.

Wall flow substrates may also be formed of ceramic fiber composite materials, such as those formed from cordierite and silicon carbide. Such materials are able to withstand the environment, particularly high temperatures, encountered in treating the exhaust streams.

The substrates can be a high porosity substrate. The term “high porosity substrate” refers to a substrate having a porosity of between about 40% and about 80%. The high porosity substrate can have a porosity preferably of at least about 45%, more preferably of at least about 50%. The high porosity substrate can have a porosity preferably of less than about 75%, more preferably of less than about 70%. The term porosity, as used herein, refers to the total porosity, preferably as measured with mercury porosimetry.

Preferably, the substrate can be cordierite, a high porosity cordierite, a metallic substrate, an extruded SCR, a filter or an SCRF.

Catalyst Configurations

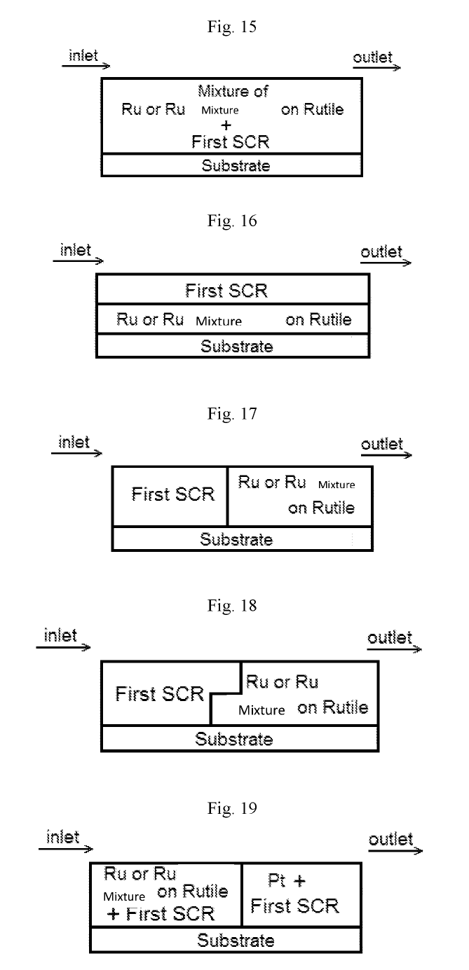

An ASC catalyst comprising a first SCR catalyst and Ru or a Ru mixture, such as a Pt and Ru mixture, on a support having a rutile phase can be present in a variety of configurations as shown in FIGS. 15 to 19 and described below.

FIG. 15 is a diagram of a configuration in which an ASC catalyst is a single layer catalyst comprising a SCR/ASC mixture of a first SCR catalyst and Ru or a Ru mixture, such as a Pt and Ru mixture, on a support having a rutile phase, where the SCR/ASC mixture is positioned on a substrate.

FIG. 16 is a diagram of a configuration in which an ASC catalyst is a bi-layer with a top layer comprising a first SCR catalyst and a bottom layer comprising Ru or a Ru mixture, such as a Pt and Ru mixture, on a support having a rutile phase, where the bottom layer is positioned on a substrate.

FIG. 17 is a diagram of a configuration in which an ASC catalyst is a single layer catalyst comprising a first zone and a second zone, where the first zone comprises a first SCR catalyst and the second zones comprises Ru or a Ru mixture, such as a Pt and Ru mixture, on a support having a rutile phase, where the first zone is located adjacent to, and upstream of, the second zone and the first zone and the second zone are positioned on a substrate.

FIG. 18 is a diagram of a configuration in which an ASC catalyst comprising a first zone and a second zone, where the first zone comprises a first SCR catalyst and the second zone comprises Ru or a Ru mixture, such as a Pt and Ru mixture, on a support having a rutile phase, where the first zone is located adjacent to, and upstream of, the second zone, the second zone comprises a portion having a stepped shape, and a portion of the first zone covers the portion of the second zone having the stepped shape.

FIG. 19 is a diagram of a configuration in which an ASC catalyst is a single layer catalyst comprising a first zone comprising a mixture of a first SCR catalyst and Ru or a Ru mixture, such as a Pt and Ru mixture, on a support having a rutile phase and a second zone, comprising a mixture of Pt and a first SCR, where the first zone is located adjacent to, and upstream of, the second zone and the first zone and the second zone are positioned on a substrate.

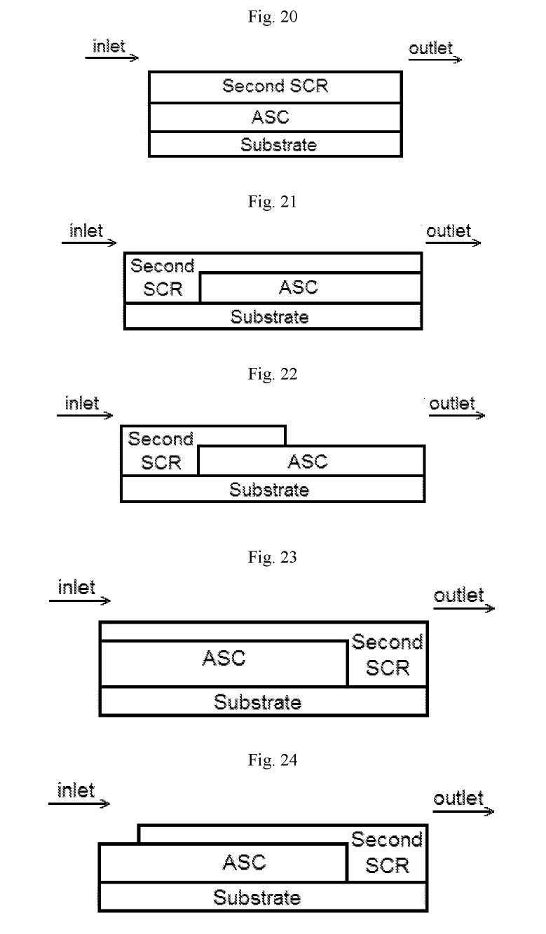

An ASC catalyst comprising a first SCR catalyst and Ru or a Ru mixture, such as a Pt and Ru mixture, on a support having a rutile phase and a second SCR catalyst can be present in a variety of configurations as shown in FIGS. 20 to 25 and described below.

FIG. 20 is a diagram of a configuration in which a top layer comprising a second SCR catalyst is located over a bottom layer comprising an ASC, where the ASC is in one of the configurations shown in FIGS. 15-19, and the bottom layer is positioned on a substrate.

FIG. 21 is a diagram of a configuration in which a layer comprising a second SCR catalyst is located both adjacent to, and completely covers, an ASC layer, where the ASC is in one of the configurations shown in FIGS. 15-19, the portion of the second SCR catalyst adjacent to the bottom layer is located upstream of the bottom layer, and both the ASC layer and the portion of the second SCR layer adjacent to the ASC layer are positioned on a substrate.

FIG. 22 is a diagram of a configuration in which a layer comprising a second SCR catalyst is located both adjacent to, and partially covers, an ASC layer, where the ASC is in one of the configurations shown in FIGS. 15-19, the portion of the second SCR catalyst adjacent to the bottom layer is located upstream of the bottom layer, and both the ASC layer and the portion of the second SCR layer adjacent to the ASC layer are positioned on a substrate.

FIG. 23 is a diagram of a configuration in which a layer comprising a second SCR catalyst is located both adjacent to, and completely covers, an ASC layer, where the ASC is in one of the configurations shown in FIGS. 15-19, the portion of the second SCR catalyst adjacent to the bottom layer is located downstream of the bottom layer, and both the ASC layer and the portion of the second SCR layer adjacent to the ASC layer are positioned on a substrate.

FIG. 24 is a diagram of a configuration in which a layer comprising a second SCR catalyst is located both adjacent to, and partially covers, an ASC layer, where the ASC is in one of the configurations shown in FIGS. 15-19, the portion of the second SCR catalyst adjacent to the bottom layer is located upstream of the ASC layer, and both the ASC layer and the portion of the second SCR layer adjacent to the ASC layer are positioned on a substrate.

FIG. 25 is a diagram of a configuration in which three layers are located over a substrate, where the bottom layer, which is located on the substrate, comprises a third SCR catalyst, the bottom layer is partially covered by a middle layer comprising an ASC layer, where the ASC is in one of the configurations shown in FIGS. 15-19, and a top layer, comprising a second SCR catalyst, completely covers the middle layer, where the uncovered portion of the bottom layer in on the upstream portion of the bottom layer.

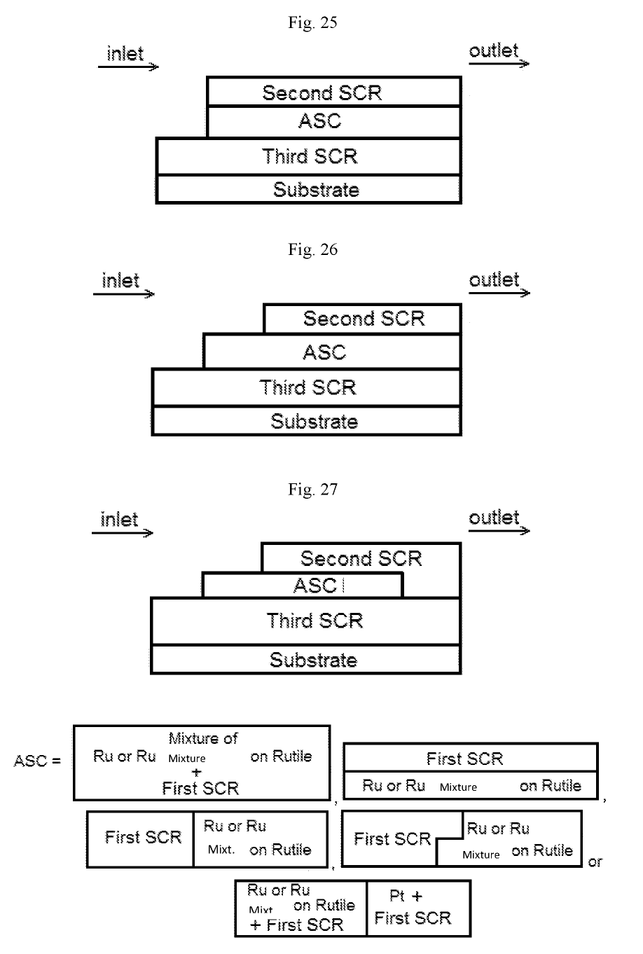

An ASC catalyst comprising a first SCR catalyst and Ru or a Ru mixture, such as a Pt and Ru mixture, on a support having a rutile phase, a second SCR catalyst and a third SCR catalyst can be present in a variety of configurations as shown in FIGS. 26 to 29 and described below.

FIG. 26 is a diagram of a configuration in which three layers are located over a substrate, where the bottom layer, which is located on the substrate, comprises a third SCR catalyst, the bottom layer is partially covered by a middle layer comprising an ASC layer, where the ASC is in one of the configurations shown in FIGS. 15-19, and a top layer, comprising a second SCR catalyst, completely covers the middle layer, where the uncovered portions of the bottom layer and the middle layer are on the upstream portion of the bottom layer and the ASC layer, respectively.

FIG. 27 is a diagram of a configuration in which three layers are located over a substrate, where the bottom layer, which is located on the substrate, comprises a third SCR catalyst, the bottom layer is partially covered by a middle layer comprising an ASC layer, where the ASC is in one of the configurations shown in FIGS. 15-19, and a top layer, comprising a second SCR catalyst, partially covers the middle layer, where the bottom layer contains two portions that are not covered by the middle layer, where the two portions are from the inlet end and the outlet e, and a portion of the top layer is located downstream, adjacent to the ASC layer and is located over the bottom layer.

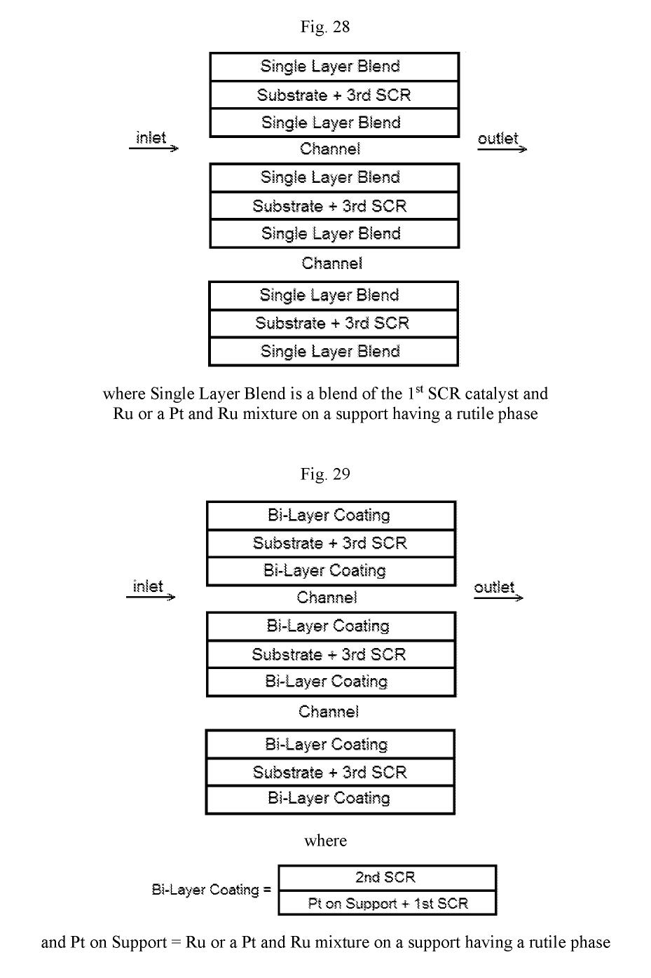

FIG. 28 is a diagram of a configuration in which a single layer blend of an ammonia slip catalyst comprising the 1st SCR catalyst and Ru or a Ru mixture, such as a Pt and Ru mixture, on a support having a rutile phase is located on each side of a substrate containing a third SCR catalyst.

FIG. 29 is a diagram of a configuration in which a bi-layer coating having a bottom layer comprising a mixture of Ru or a Ru mixture, such as a Pt and Ru mixture, on a support having a rutile phase and a first SCR catalyst with a top layer comprising a second SCR catalyst is located on each side of a substrate containing a third SCR catalyst.

The ammonia slip catalyst can be a single layer with the first SCR catalyst located upstream of the oxidation catalyst. The ammonia slip catalyst can be a blend of the first SCR catalyst with one or both of Ru and Pt. The ammonia oxidation catalyst can comprise the first SCR catalyst in an extruded substrate and the oxidation catalyst as a coating on the extruded substrate.

Catalyst articles can be prepared by applying a washcoat comprising a blend of platinum on a siliceous support and a first SCR catalyst, where the first SCR catalyst is preferably a Cu-SCR catalyst or an Fe-SCR catalyst, to the inlet side of a substrate using a method known in the art. After application of the washcoat, the composition can be dried and calcined. When the composition comprises a second SCR, the second SCR can be applied in a separate washcoat to a calcined article having the bottom layer, as described above. After the second washcoat is applied, it can be dried and calcined as performed for the first layer.

The substrate with the platinum containing layer can be dried and calcined at a temperature within the range of 300° C. to 1200° C., preferably 400° C. to 700° C., and more preferably 450° C. to 650° C. The calcination is preferably done under dry conditions, but it can also be performed hydrothermally, i.e., in the presence of some moisture content. Calcination can be performed for a time of between about 30 minutes and about 4 hours, preferably between about 30 minutes and about 2 hours, more preferably between about 30 minutes and about 1 hour.

An exhaust system can comprise a catalyst of the first aspect of the invention and a means for forming NH₃ in the exhaust gas. An exhaust system can further comprise a second catalyst selected from the group consisting of a diesel oxidation catalyst (DOC), a diesel exotherm catalyst (DEC), a selective catalytic reduction on filter (SCRF) or a catalyzed soot filter (CSF), where the second catalyst is located downstream of the catalyst of the first aspect of the invention. An exhaust system can further comprise a second catalyst selected from the group consisting of an SCR catalyst, a selective catalytic reduction on filter (SCRF), a diesel oxidation catalyst (DOC), a diesel exotherm catalyst (DEC), a NOx adsorber catalyst (NAC) (such as a lean NOx trap (LNT), a NAC, a passive NOx adsorber (PNA), a catalyzed soot filter (CSF), or a Cold Start Concept (CSC) catalyst, where the second catalyst is located upstream of the catalyst of the first aspect of the invention.

An exhaust system can comprise a catalyst of the first aspect of the invention, an SCR catalyst and DOC catalyst, where the SCR catalyst is located between the catalyst of the first aspect of the invention and the DOC catalyst. The exhaust system can comprise a platinum group metal before an SCR catalyst where the amount of the platinum group metal is sufficient to generate an exotherm. The exhaust system can further comprise a promoted-Ce—Zr or a promoted-MnO₂ located downstream of the catalyst of the first aspect of the invention.

An engine can comprise an exhaust system as described above. The engine can be an engine on a vehicle, a stationary engine, an engine in a power plant, or a gas turbine.

A vehicle can comprise an exhaust system comprising a catalyst of the first aspect of the invention and a means for forming NH₃ in the exhaust gas. The vehicle can be a car, a light truck, a heavy duty truck or a boat.

A method of improving the N₂ yield from ammonia in an exhaust gas at a temperature from about 250° C. to about 300° C. comprises contacting an exhaust gas comprising ammonia with a catalyst of the first aspect of the invention. The improvement in yield can be about 10% to about 20% compared to a catalyst comprising a comparable formulation in which the first SCR catalyst is present as a first layer and the platinum on a siliceous support is present in a second layer and gas comprising NH₃ passes through the first layer before passing through the second layer.

A method of reducing N₂O formation from NH₃ in an exhaust gas comprises contacting an exhaust gas comprising ammonia with a catalyst of the first aspect of the invention. The reduction in N₂O formation can be about 20% to about 40% compared to a catalyst comprising a comparable formulation in which the first SCR catalyst is present as a first layer and the platinum on a siliceous support is present in a second layer and gas comprising NH₃ passes through the first layer before passing through the second layer.

By supporting Ru on a rutile phase of TiO₂, it has been found that the Ru is stable to higher temperatures than when supported on mixed phases of TiO₂ (such as P25 TiO₂). Supporting Ru on other supports having a rutile phase can have the same improved stability as seen when Ru is supported on rutile TiO₂. Ru based catalysts can also offer improved N₂O selectivity to the currently used Pt based catalysts.

Ruthenium on rutile based supports for NH₃-slip applications have not been reported and offer superior N₂O selectivity compared to Pt based NH₃-slip catalysts. Ru on rutile catalysts also offer increased stability over Ru supported on non-rutile structured supports as well as better activity.

Lower N₂O selectivity in NH₃-slip applications can occur while retaining high activity along with improved stability over other Ru based catalysts Ru or Pt and Ru mixtures can be incorporated into a single layer ASC catalyst due to reduced N₂O formation. As a single layer, NH₃, CO and HC lightoffs would occur at low temperatures and higher conversions can be achieved.

Current ASC catalysts require a thick layer of an SCR catalyst above the oxidation layer to prevent unselective oxidation of NH₃ to N₂O. This thick SCR catalyst layer creates a diffusion barrier that increases the lightoff temperatures and reduces maximum conversions, thus preventing the catalyst from operating at high space velocity and driving the use of higher PGM loadings. A single layer system can enable higher NH₃ conversions and reduced PGM loadings.

The following examples merely illustrate the invention; the skilled person will recognize many variations that are within the spirit of the invention and scope of the claims.

### Examples

### Example 1—Comparison of the Use of Ru on Rutile to Results Described in Qingquan Lin, et al., J. Mater. Chem. A. 2014, 2, 5178

3% Ruthenium on nano-rutile was prepared by diluting 55.017 g of ruthenium nitrosyl nitrate solution (13.9% Ru, JM Chem) with 5 ml with demineralised H₂O. This solution was added to 251.44 g of nano-rutile TiO₂ (Sigma Aldrich) and the mixture was mixed in a speed mixer at 2,000 rpm for 10 seconds. The catalyst was dried for four hours at 105° C. before being heated at 400° C. for 1 hour.

Powder samples of the catalyst were obtained by pelletizing the original samples, crushing the pellets, and then passing the resulting powder through a 255-350 μm sieve. The sieved powders are loaded into a synthetic catalyst activity test (SCAT) reactor and tested using the following gas mixture (at inlet): 400 ppm N₂O, either 0 or 12% O₂, with the balance N₂ at a space velocity of 30,000 h⁻¹.

The sample was heated gradually from 150° C. to 550° C. at 5° C./min, and the composition of the off-gases was analyzed using FTIR spectroscopy to determine the concentration of N₂O.

The results, shown in FIG. 2, indicate that from about 175 to 250° C., there was less than about 7% (375/400 ppm) conversion of N₂O and at 300° C., there was about 15% (340/400 ppm) conversion of N₂O. This amount of conversion is much lower than that described by Qingquan Lin et al. (J. Mater Chem A., 2014, 2, 5178) as shown in FIG. 1, where 5% Ru on rutile showed over 80% conversion at 300° C., and the least active catalysts (5% Ru on SiO₂ or alumina) had only approximately 20% conversion of N₂O.

### Example 2. 0.5% Pt on Alumina

Samples were prepared by placing an aqueous solution of platinum (II) nitrate on alumina. The treated alumina was dried at 120° C. for 2 hours and then calcined at 500° C. for 4 hours.

Aged samples were prepared by treating the samples at 620° C. for 100 h under an atmosphere of air containing 10% H₂O.

### Example 3. 0.5% Ru on Alumina

Samples were prepared by placing an aqueous solution of ruthenium nitrosyl nitrate on alumina. The treated alumina was dried at 120° C. for 2 hours and then calcined at 500° C. for 4 hours.

Aged samples were prepared by treating the samples at 620° C. for 100 h under an atmosphere of air containing 10% H₂O.

### Example 4. Catalytic Activity of Example 1 and 2

Samples of Example 2 and 3 were tested to determine the amount of NH₃ conversion and N₂O formation at temperatures from 200 to 500° C. Powder samples of the catalyst were obtained by pelletizing the original samples, crushing the pellets, and then passing the resulting powder through a 255-350 μm sieve. The sieved powders are loaded into a synthetic catalyst activity test (SCAT) reactor and tested using the following gas mixture (at inlet): 350 ppm NH₃, 4.6% H₂O, 14% O₂, 5% CO₂ with the balance Na at a space velocity of 60,000 h⁻¹. The temperature increased at a rate of 5° C./min.

### Example 5. Sample Analysis by XRD

Commercially samples of anatase titania and rutile titania were obtain from Alfa Aesar.

A mixture of anatase and rutile titania was made by mixing an equal amount, by weight, of each anatase titania and rutile titania.

A sample of 5% Ru on rutile was prepared by diluting 119.32 g of ruthenium nitrosyl nitrate solution (13.79% Ru, JM Chem) to 75 ml with demineralised H₂O. This solution was added dropwise to 313.77 g of rutile TiO₂ (Alfa Aesar) as the powder was continually stirred in a paddle mixer. The addition was carried out in 2 steps with 40 ml of Ru solution added initially before drying overnight at 105° C. and then the rest of the solution was added to the powder. Approximately 5 ml of demineralised H₂O was used to rinse out the Ru solution container and added to the mixture. The catalyst was dried for several hours at 105° C. before being heated at 400° C. for 1 hour.

A sample of 3% Ru on rutile was prepared using the method described above for preparing 5% Ru on rutile, except that the loading of Ru was changed to 3%.

A sample of 3% Ru on anatase was prepared using the method described above for preparing 5% Ru on rutile, except that anatase was used in place of rutile and the loading of Ru was changed to 3%.

A sample of 3% Ru on a mixture of anatase and rutile (P25 TiO₂) was prepared using the method described above for preparing 5% Ru on rutile, except that a 1:3 mixture of anatase and rutile (P25 TiO₂) was used in place of rutile and the loading of Ru was changed to 3%.

XRD spectra were determined using a Bruker AXS D8 diffractometer. The following information relates to the diffractometer and the procedures used in obtaining the XRD spectra:

| | |
|---|---|
| Radiation | Cu Kα |
| Scan range | 10 to 130° 2θ |
| Step size | 0.02° |
| Scan mode | θ/θ coupled |
| Tube voltage, Current | 40 kV, 40 mA |
| Temperature | Ambient |
| Detector | Lynxeye PSD |
| Phase Identification | Software: Bruker DIFFRAC.EVA Release 2015, |
| | Version 4.1.1 |
| | Database: ICDD PDF Files: PDF-4+ 2015 |
| Crystallite Size and | Software: Bruker-AXS TOPAS 5 (1999-2014) |
| Lattice Parameter | Rietveld analysis: A complete-powder diffraction- |
| Measurements | pattern fitting technique using a full structural |
| | model. Crystallite size calculated using the |
| | LVol-IB method. |
| Sample preparation | Powdered samples, typically <50 μm particle |
| | size were packed in flat plate sample holders or |
| | borosilicate glass capillaries depending on the |
| | mode of measurement. |

An XRD spectra of anatase TiO₂ is shown in FIG. 5. Peaks associated with anatase are found at approximately 25.1, 37.7, 48.1, 53.8 and 55.1 2θ°.

An XRD spectra of rutile TiO₂ are shown in FIG. 6. Peaks associated with rutile are found at approximately 27.4, 36.1, 39.2, 41.3, 44.0, 54.3 and 56.7 2θ°

An overlay of the XRD spectra of anatase and rutile TiO₂ is shown in FIG. 7. Peaks associated with anatase, at approximately 25.3, 37.8, 48.0 and 55.0 2θ° are distinguishable from the peaks of rutile.

A simulated ruthenium oxide (RuO₂) XRD spectra is shown in FIG. 8. The three major peaks for RuO₂ are located at approximately 28.0, 35.0 and 40.1 2θ°. (Linus Pauling File (LPF)—See P. Villars et al, The Pauling File, Binaries Edition, Journal of Alloys and Compounds, Vol. 367; Issues 1-2, 24 Mar. 2004, Pages 293-297; and P. Villars, et al., The Linus Pauling File (LPF) and its application to materials design, Journal of Alloys and Compounds, Vol. 279, Issue 1, 4 Sep. 1998, Pages 1-7)

An XRD spectra of a sample of 3% Ru on anatase is shown in FIG. 9. This spectra contains peaks from both RuO₂ (28.1 and 35.2° 2θ) and anatase. (25.1, 37.8, 48.1, 53.8 and 55.2 2θ°) The RuO₂ peaks at about 40.1 2θ° would be too small to see because of the low Ru loading.

An overlay of the XRD spectra of anatase, RuO2 and 3% Ru on anatase is shown in FIG. 10. Peaks associated with RuO₂, at approximately 28.0, 35.0 and 40.0 2θ° are distinguishable from the peaks of anatase.

An XRD spectra of a sample of 3% Ru on rutile and 5% Ru on rutile is shown in FIGS. 11 and 12. The three major peaks for RuO₂ are located at major peaks associated with rutile.

An overlay of the spectra of rutile and 5% Ru on rutile is shown in FIG. 13. Peaks associated with RuO₂, at approximately 28.0, 35.0 and 40.0 2θ° are not distinguishable from the peaks of rutile.

An XRD spectra of a sample of 3% Ru on a mixture of anatase and rutile is shown in FIG. 14. Peaks from both anatase and rutile are observed, but the peaks from Ru are not distinguishable from the peaks of rutile.

### Example 6

A sample of 3% Ru on anatase was prepared using the method described above for preparing 5% Ru on rutile, except that anatase was used in place of rutile and the amount of Ru were adjusted to obtain 3% Ru on anatase instead of 5% Ru.

A sample of 3% Ru on gamma alumina was prepared using the method described above for preparing 5% Ru on rutile, except that gamma alumina was used in place of rutile.

A sample of 0.5% Pt on alumina was prepared Samples were prepared by placing an aqueous solution of platinum (II) nitrate on alumina. The treated alumina was dried at 120° C. for 2 hours and then calcined at 500° C. for 4 hours.

A sample of 0.5% Pt on gamma alumina was prepared using the method described above for preparing 0.5% Pt on alumina, except that gamma alumina was used in place of alumina.

### Example 7

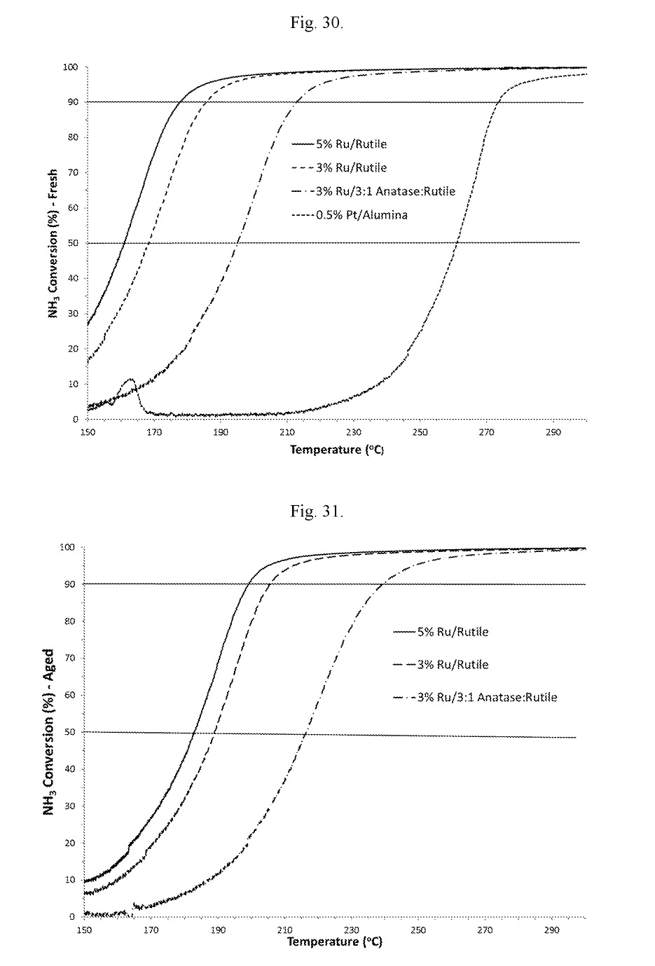

Fresh samples of 3% Ru on rutile, 5% Ru on rutile, 3% Ru on anatase and 0.5% Pt/alumina were tested to determine the amount of NH₃ conversion and N₂O formation at temperatures from 200 to 500° C. using the same conditions described in Example 4. FIG. 30 shows that both the 3% and 5% Ru on rutile samples converted NH₃ at lower temperatures than 3% Ru on anatase and at much lower temperatures than 0.5% Pt on alumina. The temperatures at which there was 50% and 90% NH₃ conversion are shown in the table below.

Approximate Temperature ° C.

| Catalyst (Fresh) | 50% Conversion | 90% Conversion |
|---|---|---|
| 5% Ru/rutile | 160 | 175 |
| 3% Ru/rutile | 170 | 185 |
| 3% Ru/anatase | 195 | 215 |
| 0.5% Pt on alumina | 260 | 275 |

Fresh samples of 3% Ru on rutile, 5% Ru on rutile, 3% Ru on a 3:1 mixture of anatase:rutile and 0.5% Pt/alumina were tested to determine the amount of NH₃ conversion and N₂O formation at temperatures from 200 to 500° C. (0.4 g of 250-355 μm pellets): 500 ppm NH₃, 10% O₂, 5% H₂O, 5% CO₂, 300 ppm CO, N₂ balance, SV=50K. FIG. 30 shows that both the 3% and 5% Ru on rutile samples converted NH₃ at lower temperatures than 3% Ru on anatase and at much lower temperatures than 0.5% Pt on alumina. The temperatures at which there was 50% and 90% NH₃ conversion are shown in the table below.

Approximate Temperature ° C.

| Catalyst (Fresh) | 50% Conversion | 90% Conversion |
|---|---|---|
| 5% Ru/rutile | 160 | 175 |
| 3% Ru/rutile | 170 | 185 |
| 3% Ru/3:1 anatase:rutile | 195 | 215 |
| 0.5% Pt on alumina | 260 | 275 |

Aged samples of 3% Ru on rutile, 5% Ru on rutile and 3% Ru on a 3:1 mixture of anatase:rutile were prepared by treating material prepared in Example 5 to hydrothermal aging for 100 hrs at 650 C.° with 10% steam in air. The aged samples were tested as described above for the fresh samples.

FIG. 31 shows that both the 3% and 5% Ru on rutile samples converted NH₃ at lower temperatures than 3% Ru on a 3:1 mixture of anatase:rutile. The temperatures at which there was 50% and 90% NH₃ conversion are shown in the table below.

Approximate Temperature ° C.

| Catalyst (Fresh) | 50% Conversion | 90% Conversion |
|---|---|---|
| 5% Ru/rutile | 185 | 200 |
| 3% Ru/rutile | 190 | 205 |
| 3% Ru/3:1 anatase:rutile | 220 | 240 |

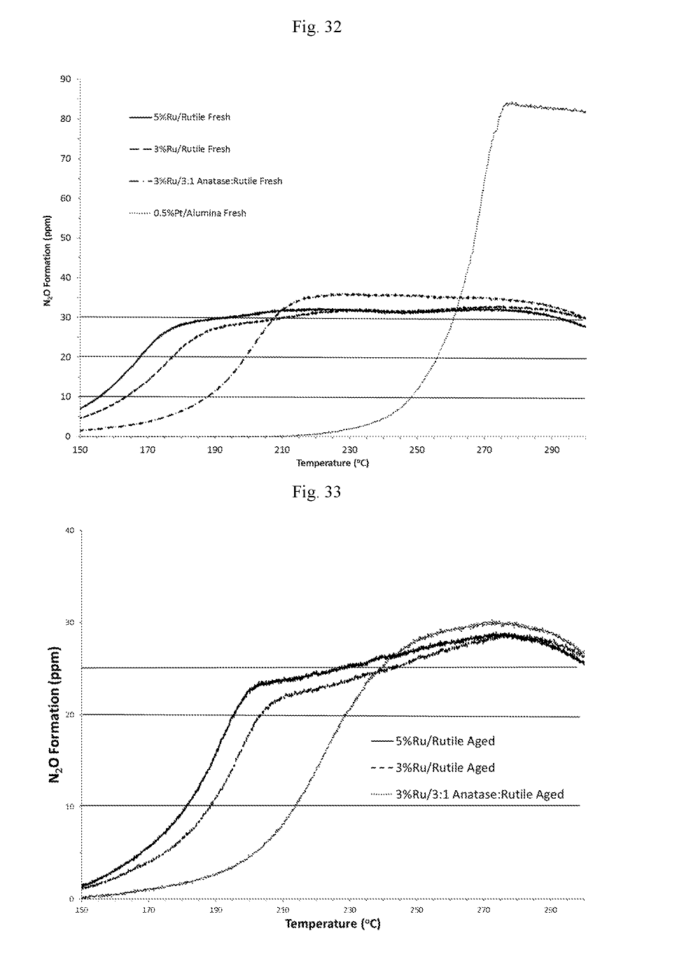

The fresh and aged samples were also analysed to determine the formation of N₂O. FIGS. 32 and 33 show the concentrations of N₂O. The maximum concentration of N₂O from the fresh samples containing Ru were between about 30-35 ppm, while the maximum concentration from the 0.5% Pt/alumina was about 80%. The temperatures at which the concentration of N₂O was 10, 20 and 30 ppm in the fresh samples are shown below.

| | Approximate Temperature ° C. | | |
|---|---|---|---|
| Catalyst (Fresh) | 10 ppm N₂O | 20 ppm N₂O | 30 ppm N₂O |
| 5% Ru/rutile | 155 | 167 | 195 |
| 3% Ru/rutile | 162 | 177 | 215 |
| 3% Ru/3:1 anatase:rutile | 187 | 200 | 210 |
| 0.5% Pt/alumina | 245 | 255 | 260 |

The temperatures at which the concentration of N₂O was 10 and 20 ppm in the aged samples are shown below.

Approximate Temperature ° C.

| Catalyst (Fresh) | 10 ppm N₂O | 20 ppm N₂O |
|---|---|---|
| 5% Ru/rutile | 180 | 195 |
| 3% Ru/rutile | 190 | 205 |
| 3% Ru/3:1 anatase:rutile | 215 | 230 |

### Example 8. Pt on Gamma Alumina and Ru on Rutile or Gamma Alumina

Fresh and aged samples of 3% and 5% Ru on rutile, 3% Ru on gamma alumina and 0.5% Pt on gamma alumina were used to determine their selectivity in forming N₂O. The aged samples were prepared by treating the samples at 550° C. for 100 h under an atmosphere of air containing 10% H₂O.

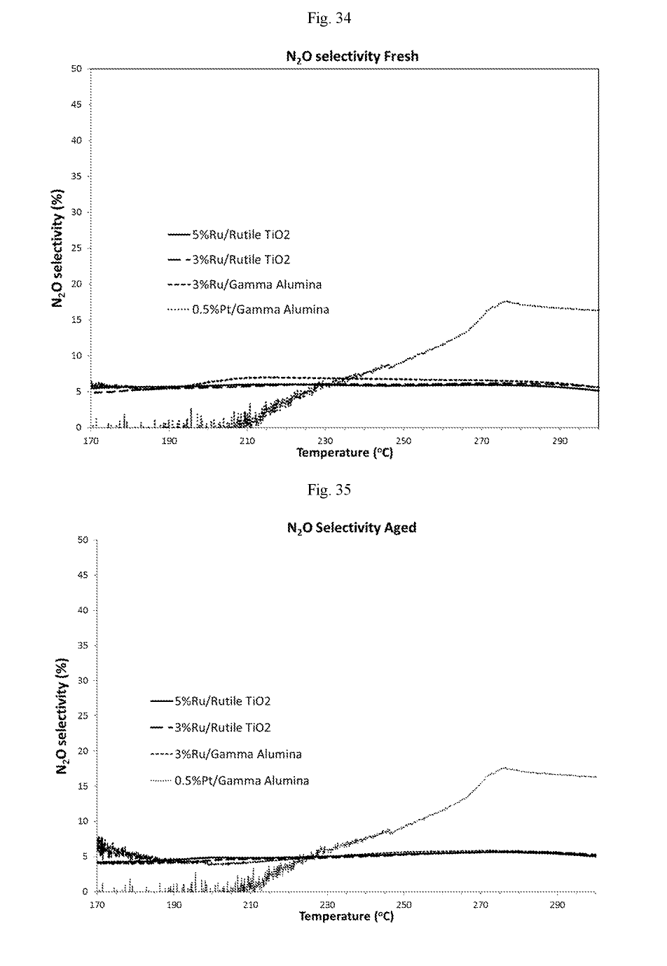

Each of the samples comprising Ru had about 5% N₂O selectivity at temperatures from 170 to 300° C., while the sample comprising Pt had selectivity of about 0 from 170 to about 210° C., because there was no significant conversion of NH₃, and N₂O selectivity increased to about 15% from 270-300° C. as NH₃ conversion occurred. (FIGS. 34 and 35)

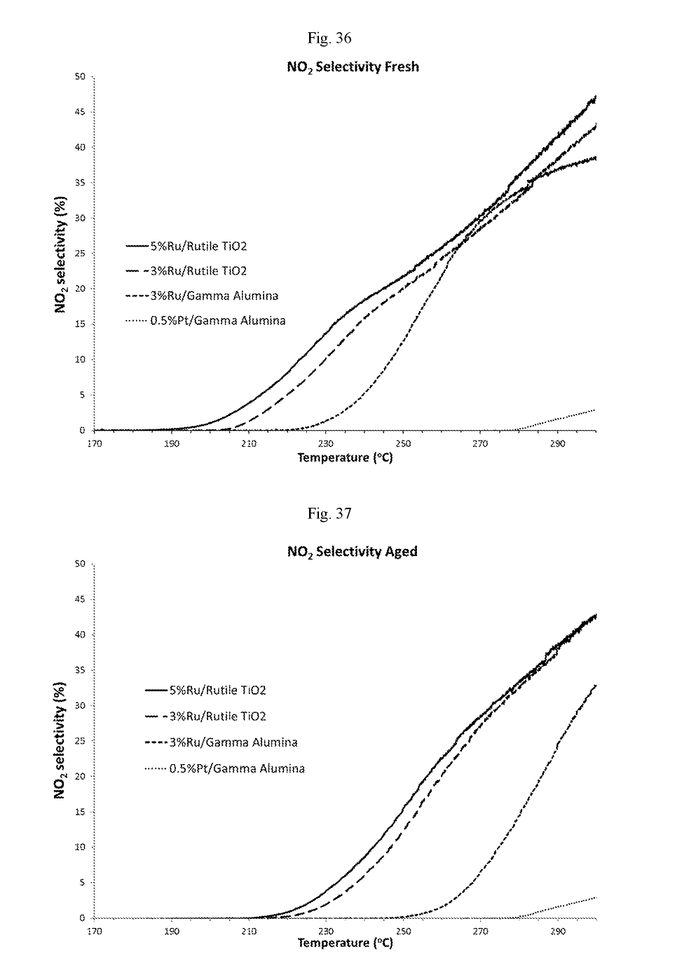

The above fresh samples were also used to determine their NO₂ selectivity (FIG. 36). Samples comprising 5% and 3% Ru on rutile began having NO₂ selectivity starting at about 190 and 205° C., respectively. The selectivity in these samples increased in an approximately linear relationship with an increase in temperature and had about 43% and 47% selectivity at 300° C. NO₂ selectivity in the 3% Ru on gamma alumina was delay relative to the Ru sample on rutile, with NO₂ selectivity beginning at about 225° C. and increasing in a non-linear relationship to temperature with about 38% selectivity at 300° C. NO₂ selectivity from the 0.5% Pt on alumina began at about 280 C and reached about 3% NO₂ selectivity at 300° C.

The above aged samples were also used to determine their NO₂ selectivity (FIG. 37). Fresh samples comprising 5% and 3% Ru on rutile began having NO₂ selectivity starting at about 205 and 210° C., respectively. The selectivity in these samples increased with an increase in temperature and had about 43% selectivity at 300° C. NO₂ selectivity in the fresh 3% Ru on gamma alumina was delay relative to the Ru sample on rutile, with NO₂ selectivity beginning at about 250° C. and increasing with temperature to about 33% selectivity at 300° C. NO₂ selectivity from the fresh 0.5% Pt on alumina began at about 280 C and reached about 3% NO₂ selectivity at 300° C.

The preceding examples are intended only as illustrations; the following claims define the scope of the invention.

We claim:

1. An ammonia slip catalyst comprising:
a first SCR catalyst,
an oxidation catalyst comprising ruthenium or a ruthenium mixture on a support comprising a rutile phase, and
a substrate.

2. The ammonia slip catalyst of claim 1, wherein the ruthenium mixture comprises a Pt and Ru mixture.

3. The ammonia slip catalyst of claim 1, further comprising copper, where copper is present in an amount from about 0.5 to about 5%, relative to the weight of Ru, and the performance of the ASC catalyst for removal of ammonia is increased by 0.5 to 5% relative to a comparable catalyst without copper.

4. The ammonia slip catalyst of claim 1, where the ammonia slip catalyst is a bi-layer having a top layer comprising the first SCR catalyst and a bottom layer comprising the oxidation catalyst comprising ruthenium or a Ru mixture on a support comprising a rutile phase.

5. The ammonia slip catalyst of claim 1, where the ammonia slip catalyst comprises a single layer comprising a mixture of the first SCR catalyst and the oxidation catalyst comprising ruthenium or a Ru mixture on a support comprising a rutile phase.

6. The ammonia slip catalyst of claim 1, wherein the oxidation catalyst further comprises Pt on the same support or a different support.

7. The ammonia slip catalyst of claim 6, where the ammonia slip catalyst is a single layer comprising a first zone comprising ruthenium and a second zone comprising Pt, where the first zone is positioned on an inlet side of the second zone.

8. The ammonia slip catalyst of claim 7, where the first SCR catalyst is a blend with a Cu SCR catalyst, or is a layer on an extruded substrate comprising the oxidation catalyst.

9. The ammonia slip catalyst of claim 6, where the ammonia slip catalyst is a single layer comprising a mixture of the oxidation catalyst and the first SCR catalyst.

10. The ammonia slip catalyst of claim 1, where the ammonia slip catalyst is a single layer with the first SCR catalyst located upstream of the oxidation catalyst.

11. The ammonia slip catalyst of claim 1, where the catalyst provides reduced N₂O formation compared to a comparable catalyst without Ru or a Ru mixture on a support providing reduced ruthenium volatility.

12. The ammonia slip catalyst of claim 2, where the catalyst comprises Ru and Pt, where Ru and Pt are on different supports.

13. The ammonia slip catalyst of claim 12, where Pt is on a support with low ammonia storage.

14. The ammonia slip catalyst of claim 1, where the ammonia slip catalyst is a single layer comprising a blend of the oxidation catalyst and the first SCR catalyst.

15. The ammonia slip catalyst of claim 1, where ruthenium is present at from 0.1 wt % to 10 wt %, relative to the weight of the ammonia slip catalyst.

16. The ammonia slip catalyst of claim 4, further comprising a second SCR catalyst, where the second SCR catalyst is in a layer over the bi-layer ammonia slip catalyst.

17. The ammonia slip catalyst of claim 16, where the second SCR catalyst completely overlaps the bi-layer ammonia slip catalyst.

18. The ammonia slip catalyst of claim 16, where the second SCR catalyst is located upstream of the bi-layer ammonia slip catalyst.

19. The ammonia slip catalyst of claim 16, further comprising a third SCR catalyst, where the third SCR catalyst is an underlayer located under the bottom layer of the bi-layer catalyst.

20. A method of reducing N₂O formation from NH₃ in an exhaust gas, the method comprising contacting an exhaust gas comprising ammonia with an ammonia oxidation catalyst of claim 1.
